(19) United States
(12) Patent Application Publication
(10) Pub. No.: US 2026/0045538 A1
(43) Pub. Date: Feb. 12, 2026

(54) Catalyst for Lithium-Sulfur Batteries

(71) Applicant: Northeastern University, Boston, MA (US)

(72) Inventors: Sanjeev MUKERJEE, Mansfield, MA (US); Luisa Larissa Amaldo GOMES, Cambridge, MA (US); Victor Ribeiro SANCTIS, Vaud (CH); Huidong DAI, Malden, MA (US)

(21) Appl. No.: 19/292,321

(22) Filed: Aug. 6, 2025

Related U.S. Application Data
(60) Provisional application No. 63/680,059, filed on Aug. 6, 2024.

(51) Int. Cl. H01M 10/052; H01M 10/0564

(52) U.S. Cl. CPC H01M 10/052; H01M 10/0564; H01M 2300/0025

(57) ABSTRACT

The present technology provides electrolytes and methods of making electrolytes for lithium-sulfur batteries. The electrolyte includes a catalyst compound comprising an anion, a cation, and a solvent. The cation has a quaternary ammonium structure containing alkyl groups R¹-R⁴, each of which is independently selected from C2 to C8 alkyl groups, and can be unbranched, branched, or cyclic. In an embodiment, the cation is tetrabutylammonium.

### CROSS REFERENCE TO RELATED APPLICATIONS

This application claims priority to U.S. Provisional Application No. 63/680,059, filed Aug. 6, 2024, which is incorporated by reference herein in its entirety.

### STATEMENT REGARDING FEDERALLY SPONSORED RESEARCH OR DEVELOPMENT

This invention was made with government support under Grant Number 2052796 awarded by the National Science Foundation. The Government has certain rights in the invention.

### BACKGROUND

Lithium-polymer batteries currently hold a prominent position within the market for personal electronic devices and exhibit considerable potential for utilization in electric vehicles and grid storage systems. The imperative augmentation of energy density underscores the significance of optimizing cathode materials. Among these materials under consideration, sulfur stands out for its exceptional promise by possessing a notably high theoretical specific capacity of 1,675 mAh/g and an approximate theoretical specific energy density of 2,600 Wh/kg, as shown in Table 1 below.

TABLE 1

| | Theoretical Specific | |
|---|---|---|
| Battery type | Energy Density (Wh/kg) | #Cost/kWh |
| Lithium-sulfur | 2600 | 60-90 |
| Lead-acid | 140 | 80-150 |
| Nickel-Cadmium | 50-150 | 150-300 |
| LiFePO₄ | 170-190 | 100-200 |
| Ni—Mn—Co | 280-300 | 150-350 |

| Battery type | Current density (mA/cm²) |
|---|---|
| Lithium-sulfur | 14-80 |
| Li-NMC | 1.8-20* |

*Mehmaz J., 2021. IET Smart Grid.

Bloomberg, N. E. F., 2019. Bloomberg New Energy Finance.

Moreover, the sulfur cathode offers supplementary advantages, including the prospect of highlighted safety attributed to its lower battery voltage (around 2.4 V vs. Li⁰/Li⁺), as well as reduced cost and diminished toxicity relative to certain incumbent cathode materials. In essence, Li—S batteries harbor the capacity to yield energy density exceeding fivefold that of current Li-ion batteries.

While Li—S batteries offer tremendous promise, they are accompanied by notable challenges. Typically, Li—S batteries employ a lithium metal anode, liquid organic electrolyte, and composite sulfur cathode. However, inherent difficulties emerge; sulfur and the polysulfide intermediates formed during charging/discharging exhibit high resistance, with some species being insoluble in the electrolyte. Slow reaction rates of the polysulfide intermediates stemming from their reaction mechanism often lead to limited long-term cycling, impacting the battery's durability over numerous charge-discharge cycles. These formidable challenges necessitate immediate attention and concerted efforts for successful commercialization. Various methodologies are under exploration, with catalyst employment being one prominent avenue. Previous investigations have focused on leveraging catalysts to enhance the reaction rate of polysulfide intermediates. These catalysts encompass metal oxides, sulfides, phosphides, and nitrides, which either absorb or convert the polysulfide intermediates. Additionally, noteworthy is the utilization of cobalt phthalocyanine as a catalyst, targeting specific reaction steps within the battery system.

Thus, lithium-sulfur (Li—S) batteries have garnered great attention as potential candidates for next-generation energy storage systems, owing to sulfur's high theoretical specific capacity and theoretical specific energy density, 1675 mAh/g and 2600 Wh/kg, respectively Ref. 2 [1]. Additionally, the cathode offers advantages by using lower cost materials, with greater natural abundance and environmental friendliness Ref. 2 [2]. Coupled with potential improvements in safety over commercial Li⁺ batteries Ref. 2 [3], this makes Li—S batteries a very attractive alternative. However, important technical barriers must be overcome prior to commercialization.

During discharge, octasulfur (S₈) is reduced to lithium sulfide (Li₂S) through complex intermediate reactions involving the formation and reduction of long-chain lithium-polysulfides (LiPs) (Li₂SX, 5≤X≤8), intermediate-chain LiPs (Li₂SX, 3≤X≤4) and short-chain LiPs (Li₂SX, 1≤X≤2) Ref. 2 [4]. A first challenge arises due to the insulating nature of sulfur that hinders charge transfer during electrochemical reactions, affecting capacity retention and cycling performance Ref. 2 [5]. Secondly, soluble lithium-polysulfides (LiPs) can migrate towards the anode and be directly reduced at the Li metal, through a process known as the shuttle effect Ref. 2 [6]. This leads to the formation of insoluble short chain polysulfides in the Solid Electrolyte Interphase (SEI), which consumes active material and causes capacity fading Ref. 2 [7, 8]. Thirdly, undesirable side reactions between the anode and electrolyte can lead to uncontrolled dendrite growth, uneven Solid Electrolyte Interphase (SEI) formation and loss of active material that hinder safety and long-term cycling performance Ref. 2 [9, 10]. Given the significant theoretical advantages of this battery chemistry, it is critical to conduct research that remedies these challenges.

There has been extensive work on optimizing cathode design; mesoporous carbon nanoparticles can improve sulfur's conductivity, Li₂S as a cathode material avoids a metallic lithium anode and hollow nanostructures can entrap sulfur and lithium-polysulfides (LiPs) Ref. 2 [11-14]. Organic materials, metal oxides, metal-organic frameworks, metal hydroxides metal sulfides, metal nitrides, metal carbides, metal phosphides metal borides and other materials have also been investigated as sulfur hosts Ref. 2 [15]. Other efforts have focused on anode design by applying a polymer coating to the lithium anode, employing hybrid anodes that use Si nanospheres or lithiated graphite in front of the lithium metal to act as an artificial Solid Electrolyte Interphase (SEI) layer Ref. 2 [16-18]. A third general approach has been electrolyte design.

The focus on electrolyte design is a very promising approach, given the possibility to effect solvation structures, stabilize polysulfide intermediates, suppress dendrite formation, anodic corrosion and ultimately prolong cycling Ref. 2 [19]. High-Concentration Electrolytes (HCEs), like 7M Lithium bis(trifluoromethanesulfonyl)imide (LiTFSI) in 1,3-dioxolane: 1,2-dimethoxyethane (DOL:DME), can prevent lithium-polysulfides (LiPs) dissolution and help building an inorganic solid electrolyte interphase (SEI), improving cycling performance and minimizing dendritic growth Ref. 2 [20]. Unlike low concentration electrolytes (LCEs) such as 1M LiTFSI in DOL:DME where Li⁺ is preferentially coordinated by solvent molecules, in es HCEs the anion from salts in the electrolyte coordinate with the Li⁺ and occupy its solvation shell Ref. 2 [21]. Similarly, Localized High-Concentration Electrolytes (LHCEs) introduce a co-solvent in which the salt is insoluble, maintaining the Li⁺ solvation shell occupied by salt anions, while allowing for higher localized salt concentrations, lowering viscosity and increasing ionic conductivity Ref. 2 [22]. In addition, salts can impact desolvation kinetics of Li⁺, with a direct impact on cycling performance Ref. 2 [23]. In regard to LiPs, strong solvation has been shown to favor fast anode kinetics while weak solvation hinders cathode kinetics Ref. 2 [24].

Previous work has investigated gel polymer electrolytes to physically prevent LiPs migration, minimizing dendrite formation while maintaining a high ionic conductivity Ref. 2 [25]. Similarly, solid state electrolytes hope to eliminate LiPs dissolution and the shuttle effect by using inorganic, polymer or composite materials Ref. 2 [26]. For liquid electrolytes, previous work has explored the role of lithium-based anions, demonstrating the role of anion donicity on Li⁺ solvation, sulfur utilization and polysulfide solubility Ref. 2 [27]. Similarly, the NO₃⁻ anion has been shown to help form a protective layer on the anode that prolongs cycling life Ref. 2 [28]. Other works have explored the role of bis(fluorosulfonyl)-imide (FSI−), trifluoro-methansulfonate (TFMS−), bis(trifluoromethanesulfonyl) imide (TFSI−), and 2-trifluoromethyl-4,5-dicyanoimidazole (TDI−), investigating the impact of anion diffusion and mobility on interactions with lithium-polysulfides (LiPs) Ref. 2 [29]. The decomposition products of the TFSI− and FSI− have also been investigated to elucidate cycling performance Ref. 2 [30]. However, previous work has focused on lithium salts.

Table 2 below lists patents related to lithium-sulfur batteries, electrolyte additives for lithium sulfur rechargeable batteries, a battery based on organosulfur species, a non-aqueous electrolyte solution for lithium secondary battery and lithium secondary battery comprising the same, an onium-alkylsulfonate production method, lithium ion batteries, and an electrolyte composition for a lithium sulfur battery.

TABLE 2
Previous Patents on Related Topics

| Title | Main Inventor | Patent # |
|---|---|---|
| LITIUM-SULFUR | Zhencheng Zhang | US 20170033406A1 |
| BATTERIES | | |
| Electrolyte additives for | Li Yang | US00916.0036B2 |
| lithium sulfur rechargeable | | |
| batteries | | |
| Battery based on organosulfur | Gary S. Smith | US20170084953A1 |
| species | | |
| Non-aqueous electrolyte | Go Joohwan | KR102379545B1 |
| solution for lithium secondary | | |
| battery and lithium secondary | | |
| comprising the same | | |
| Onium-alkylsufonate | Nikolai Ignatyez | EP1902004B1 |
| production method | (Mykola) | |
| Lithium ion batteries | Irmgard Buchberger | US20220216519a1 |
| Electrolyte composition for | O. Grodger | CN109585909b |
| lithium sulfur battery | | |

There remains a need for better Li—S batteries in view of the challenges noted above.

### SUMMARY

The present technology focuses on electrolytes for lithium-sulfur batteries for positively effecting solvation structures, stabilizing polysulfide intermediates, suppressing dendrite formation and anodic corrosion and ultimately prolonging cycling. overcoming the challenges provides electrolytes and methods of making electrolytes for lithium-sulfur batteries.

In one aspect, the present technology provides an electrolyte for a lithium-sulfur battery. The electrolyte incorporates a catalyst compound including an anion, a cation, and a solvent. The cation has a quaternary ammonium structure corresponding to Formula (I) shown below. Each of the R¹-R⁴ groups can be independently selected from C2 to C8 alkyl groups. Each alkyl group can be unbranched, branched, or cyclic.

The technology can be further summarized in the following list of features:

1. An electrolyte for a lithium-sulfur battery, the electrolyte comprising:
(i) a catalyst compound comprising an anion and a cation;
wherein the cation has a structure corresponding to Formula (I):

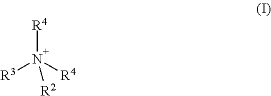

wherein each of R¹-R⁴ is independently selected from C2 to C8 alkyl groups;
wherein each alkyl group is selected from unbranched, branched and cyclic; and
(ii) a solvent.
   2. The electrolyte of claim 1, wherein said alkyl group are C3 to C6 alkyl groups.
   3. The electrolyte of claim 1 or claim 2, wherein the catalyst is a tetrabutylammonium (TBA) compound.
   4. The electrolyte of claim 3, wherein the tetrabutylammonium (compound is selected from the group consisting of tetrabutylammonium trifluoro-methanesulfonate (TBA-TFMS), tetrabutylammonium bis-trifluoro-methanesulfonimidate (TBA-FSI), tetrabutylammonium thiocyanate (TBA-SCN), tetrabutylammonium methanesulfonate (TBA-MS), tetrabutylammonium nitrate (TBA-NO₃), tetrabutylammonium perchlorate (TBA-ClO₄), and tetrabutylammonium hexafluorophosphate (TBA-PF₆).
   5. The electrolyte of any of the preceding claims, wherein the solvent is selected from the group consisting of 1,2-dimethoxyethane (DME), 1,3-dioxolane (DOL), ethanol (ETOH), dimethylacetamide (DMA), a glyme based solvent, diglyme (G2), triglyme, an ionic liquid, a hydrofluoroether, dimethyl sulfoxide (DMSO), N,N-dimethyl acetamide (DMAc), N,N-dimethyl formamide (DMF), N-methyl-2-pyrrolidone (NMP), and a combination of at least two of the aforementioned, and preferably wherein the solvent is selected from the group consisting of selected from the group consisting of 1,2-dimethoxyethane (DME), 1,3-dioxolane (DOL), ethanol (ETOH), dimethylacetamide (DMA), and combinations of two or more of the aforementioned.
   6. The electrolyte of any of the preceding claims, wherein the solvent has a polysulfide solubility up to around 0.5 M, an electrochemical stability in a range of 1.2 to 4.2 V, and an ionic conductivity in a range of 1 to 20 mS/cm at 25° C.
   7. The electrolyte of any of the preceding claims, wherein the concentration of the catalyst in the electrolyte is in a range from 0.01 M to 1.0 M, and preferably in a range of 0.01 M to 0.10 M.
   8. The electrolyte of any of the preceding claims, wherein the catalyst is present in the electrolyte in a range of 1 wt. % to 10 wt. %, preferably in a range of 1 wt. % to 8 wt. %, more preferably in a range of 1 wt. % to 6 wt. %, and most preferably at a concentration of about 5 wt. %.
   9. A lithium-sulfur battery comprising the electrolyte of any of the preceding claims.
   10. The lithium-sulfur battery of claim 9, configured as a rechargeable coin battery.
   11. An electronic device comprising the lithium-sulfur battery of claim 9 or claim 10.
   12. A method of making an electrolyte for a lithium-sulfur battery, the method comprising dissolving the catalyst of any of the preceding claims in a solvent to form the electrolyte.
   13. The method of claim 12, wherein the catalyst is a tetrabutylammonium (TBA) compound selected from the group consisting of tetrabutylammonium trifluoro-methanesulfonate (TBA-TFMS), tetrabutylammonium bis-trifluoro-methanesulfonimidate (TBA-FSI), tetrabutylammonium thiocyanate (TBA-SCN), tetrabutylammonium methanesulfonate (TBA-MS), tetrabutylammonium nitrate (TBA-NO₃), tetrabutylammonium perchlorate TBA-ClO₄), and tetrabutylammonium hexafluorophosphate (TBA-PF₆).
   14. The method of claim 12 or claim 13, wherein the solvent is selected from the group consisting of 1,2-dimethoxyethane (DME), 1,3-dioxolane (DOL), ethanol (ETOH), dimethylacetamide (DMA), a glyme based solvent, diglyme (G2), triglyme, an ionic liquid, a hydrofluoroether, dimethyl sulfoxide (DMSO), N,N-dimethyl acetamide (DMAc), N,N-dimethyl formamide (DMF), and N-methyl-2-pyrrolidone (NMP).
   15. The method of any of claims 12-14, wherein the concentration of the catalyst in the electrolyte is in a range from 0.01 M to 1.0 M, and preferably in a range of 0.01 to 0.10 M.
   16. The lithium-sulfur battery of claim 9,
wherein after 300 cycles at C/2, the lithium-sulfur battery has a specific capacity in a range of 369.76 mAh/gS to 394.83 mAh/gS.
   17. The lithium-sulfur battery of claim 9,
wherein after 300 cycles at C/2, the lithium-sulfur battery has a capacity decay rate per cycle in a range of 0.07% to 0.10%.
   18. The lithium-sulfur battery of claim 9,
wherein after 300 cycles at 1C, the lithium-sulfur battery has a specific capacity in a range of 395.74 mAh/gS to 397.48 mAh/gS.
   19. The lithium-sulfur battery of claim 9,
wherein after 300 cycles at 1C, the lithium-sulfur battery has a capacity fading per cycle after stabilization in a range of 0.08% to 0.12%.
   20. The lithium-sulfur battery of claim 9,
wherein at 1C, the lithium-sulfur battery has a specific capacity in a range of 443.84 mAh/gS to 540.6 mAh/gS.

As used herein, reference numbers refer to Reference List 1 (Ref. 1) unless specified that the reference number refers to Reference List 2 with the notation of “Ref. 2”.

As used herein:
the term “C-rate” refers to the rate at which a battery charges or discharges relative to its maximum capacity;
the term “C-1” refers to a discharge rate at which a battery can be fully discharged in one hour;
the term “C/2” refers a discharge rate where the battery is discharged at half its capacity over a two-hour period;
the phrase “discharge capacity” refers to total amount of electrical energy a battery can deliver during discharge;

### BRIEF DESCRIPTION OF THE DRAWINGS

FIG. 1 is a schematic illustration of a Li—S battery in accordance with prior art.

FIG. 2a shows the chemical reactions for the formations of various lithium-sulfur compounds battery in accordance with the prior art.

FIG. 2b shows the electrochemical features including voltage versus capacity for the octasulfur and lithium-sulfur compounds shown in FIG. 2a battery in accordance with prior art.

FIG. 3 is a schematic illustration of the assembly of a CR2032 coin cell battery battery in accordance with prior art.

FIG. 4 shows schematics of the chemical structures of the Tetrabutylammonium (TBA)-based catalysts tested in this application

FIG. 5 shows Rate Capability including discharge capacity at distinct C-rates for coin cells containing electrolyte at different Tetrabutylammonium bis-trifluoro-methanesulfonimidate (TBA-FSI) additive concentrations compared to coin cells containing the baseline electrolyte containing no catalyst at corresponding C-rates

FIG. 6 shows Rate capability including discharge capacity at distinct C-rates for coin cells containing electrolyte containing respectively 0.01 M of Tetrabutylammonium thiocyanate (TBA-SCN), Tetrabutylammonium bis-trifluoro-methanesulfonimidate (TBA-FSI), Tetrabutylammonium trifluoro-methanesulfonate (TBA-TFMS), and Tetrabutylammonium methanesulfonate (TBA-MS) in comparison with a coin cell containing baseline electrolyte with no catalyst at corresponding C-rates.

FIG. 7a shows Long-term cycling performance data including discharge capacity at distinct C-rates for coin cells containing electrolyte containing respectively 5 wt. % of Tetrabutylammonium nitrate (TBA-NO3), 5 wt. % of Tetrabutylammonium hexafluoro phosphate (TBA-PF6), and 5 wt. % of Tetrabutylammonium perchlorate (TBA-ClO4) electrolyte, in comparison with coin cells containing baseline electrolyte containing no catalyst at corresponding C-rates.

FIG. 7b shows 1 Long-term cycling performance data including discharge capacity at distinct C-rates for coin cells containing electrolytes respectively 0.01M of Tetrabutylammonium thiocyanate (TBA-SCN), 0.01M Tetrabutylammonium bis-trifluoro-methanesulfonimidate (TBA-FSI) electrolyte, and 0.01M Tetrabutylammonium trifluoro-methanesulfonate (TBA-TFMS), in comparison with coin cells containing baseline electrolyte containing no catalyst at corresponding C-rates.

FIG. 8a shows the cyclic voltammetry profiles of coin cells containing baseline electrolyte with no catalyst.

FIG. 8b shows the cyclic voltammetry profiles of coin cells containing electrolyte containing 0.01M of Tetrabutylammonium methanesulfonate (TBA-MS).

FIG. 8c shows the cyclic voltammetry profiles of coin cells containing electrolyte containing 0.01M of Tetrabutylammonium trifluoro-methanesulfonate (TBA-TFMS).

FIG. 8d shows the cyclic voltammetry profiles of coin cells containing electrolyte containing 0.01 M of Tetrabutylammonium bis-trifluoro-methanesulfonimidate (TBA-FSI).

FIG. 9a shows Randles Sevcik study for cyclic voltammetry profile of the baseline electrolyte with the oxidation peaks (B and C) and the reduction peak (A).

FIG. 9b shows current versus the square root of the scan rate for peak A for baseline electrolyte containing no catalyst and electrolytes containing catalyst.

FIG. 9c shows current versus the square root of the scan rate for peak B for baseline electrolyte containing no catalyst and electrolytes containing catalyst.

FIG. 9d shows current versus the square root of the scan rate for peak C for baseline electrolyte containing no catalyst and electrolytes containing catalyst.

FIG. 10a shows first charge and discharge profiles for coin cells containing electrolyte containing respectively 0.01M of Tetrabutylammonium thiocyanate (TBA-SCN), 0.01M Tetrabutylammonium bis-trifluoro-methanesulfonimidate (TBA-FSI) electrolyte, and 0.01M Tetrabutylammonium trifluoro-methanesulfonate (TBA-TFMS), in comparison with coin cells containing baseline electrolyte containing no catalyst.

FIG. 10b shows first charge and discharge profiles for coin cells containing electrolyte containing respectively 5 wt. % of Tetrabutylammonium nitrate (TBA-NO₃), 5 wt. % of Tetrabutylammonium hexafluoro phosphate (TBA-PF₆), and 5 wt. % of Tetrabutylammonium perchlorate (TBA-ClO₄) electrolyte, in comparison with baseline electrolyte containing no catalyst.

FIG. 11a shows a molecular dynamics (MD) modeling simulation for an electrolyte system including a baseline formulation consisting of 1.0 M[S] LiTFSI in DOL/DME (1:1 by volume).

FIG. 11b shows a molecular dynamics (MD) modeling simulation for an electrolyte system including a baseline formulation consisting of 1.0 M[S] LiTFSI in DOL/DME (1:1 by volume) and incorporating 0.1 M[S] TFMS.

FIG. 11c shows a molecular dynamics (MD) modeling simulation for an electrolyte system including a baseline formulation consisting of 1.0 M[S] LiTFSI in DOL/DME (1:1 by volume) and incorporating 0.1 M[S] MS).

FIG. 11d shows plots of the coordination number (CN) and radial distribution function g(r) as a function of radial distance from MD simulations of DOL:DME (1:1, v/v) with 1 M LiTFSI

FIG. 11e shows plots of the coordination number (CN) and radial distribution function g(r) as a function of radial distance from MD simulations of DOL:DME (1:1, v/v) with 1 M LiTFSI and the addition of (e) 0.1 M TFMS−.

FIG. 11f shows plots of the coordination number (CN) and radial distribution function g(r) as a function of radial distance from MD simulations of DOL:DME (1:1, v/v) with 1 M LiTFSI and the addition of 0.1 M MS−.

FIG. 11g shows a diagram summarizing the interactions among Li⁺, DME solvent molecules, and the electrolyte additives.

FIG. 11h shows ⁷Li NMR spectra of 0.01 M LiTFSI in DOL:DME (1:1 vol %) electrolyte (pink), and with the addition of 0.01 M TFMS⁻ (blue) and 0.01 M MS⁻ (orange), where the spectra were referenced to an external standard of 1 M LiCl in D₂O (0 ppm), using coaxial tubes to adjust the chemical shift.

FIG. 12a shows cyclic voltammograms of symmetric carbon paper cells containing 0.25 M Li₂S₆ and 1 M LiTFSI in DOL:DME as catholyte recorded at a scan rate of 3 mV/s, where the system underwent three cycles, and a control cell without Li₂S₆ was included.

FIG. 12b shows cyclic voltammograms of symmetric carbon paper cells containing 0.25 M Li₂S₆ and 1 M LiTFSI in DOL:DME as catholyte with the addition of 0.01 M TFMS− recorded at a scan rate of 3 mV/s, where the system underwent three cycles, and a control cell without Li₂S₆ was included.

FIG. 12c shows a cyclic voltammograms of symmetric carbon paper cells containing 0.25 M Li₂S₆ and 1 M LiTFSI in DOL:DME as catholyte with the addition of 0.01 M MS− recorded at a scan rate of 3 mV/s, where the system underwent three cycles, and a control cell without Li₂S₆ was included.

FIG. 12d shows Li₂S nucleation studies conducted with 0.25 M Li₂S₈ and 1 M LiTFSI in DOL:DME as baseline.

FIG. 12e shows Li₂S nucleation studies conducted with 0.25 M Li₂S₈ and 1 M LiTFSI in DOL:DME with the addition of 0.01 M TFMS⁻.

FIG. 12f shows Li₂S nucleation studies conducted with 0.25 M Li₂S₈ and 1 M LiTFSI in DOL:DME with the addition of 0.01 M MS⁻.

FIG. 12g shows ⁷Li NMR spectra of 0.05 M Li₂S₆ in DOL:DME (pink), with 0.01 M TFMS− (purple) or 0.01 M MS− (orange).

FIG. 12h is a schematic illustrating polarization decoupling using galvanostatic intermittent titration technique (GITT) for Li—S cells across the depth of discharge (DoD) and state of charge (SoC).

FIG. 12i shows concentration polarization plotted across the depth of discharge (DoD).

FIG. 13a shows cyclic voltammograms (CVs) of Li—S coin cells at a scan rate of 0.2 mV/s highlighting the difference between peak A (oxidation of long chain polysulfide (Li₂Sₓ, 4≤x≤8) to S₈), and peak B (the reverse reaction).

FIG. 13b shows cyclic voltammograms (CVs) of Li—S coin cells containing 0.01M of TFMS⁻ at scan rates ranging from 0.1 to 1 mV/s (0.1 mV/s increments) for Randles-Ševčík analysis.

FIG. 13c shows Li⁺ Diffusion coefficient calculated via Randles-Ševčík analysis.

FIG. 13d shows EIS spectra of a Li—S cell containing 0.01 M of TFMS⁻ across the depth of discharge (DoD) and the corresponding discharge profile at 273.15 K.

FIG. 13e shows the effects of the additives on the activation energy of a Li—S cell calculated via Arrhenius analysis using reciprocal resistance from EIS vs. inverse temperature across the depth of discharge.

FIG. 13f shows the effects of the additives on the activation energy of a Li—S cell calculated via Arrhenius analysis using reciprocal resistance from EIS vs. inverse temperature across the state of charge.

FIG. 13g shows the rate performance tests for the baseline (pink), with 0.01M TFMS⁻ (blue) or 0.01M MS⁻ (orange).

FIG. 13h shows long-term cycling performance at C/2.

FIG. 13i shows long-term cycling performance at 1C.

FIG. 14a shows operando Raman contour plots of Li—S coin cells across the depth of discharge for the baseline, where the operando Raman is plotted alongside the discharge profile, highlighting the voltage at which the polysulfides are formed.

FIG. 14b shows the distribution of relaxation times (DRT) contour plots of Li—S coin cells across the depth of discharge for the baseline.

FIG. 14c shows the operando Raman contour plots of Li—S coin cells across the depth of discharge for the baseline with 0.01 M MS⁻, where the operando raman is plotted alongside the discharge profile, highlighting the voltage at which the polysulfides are formed.

FIG. 14d shows the distribution of relaxation times (DRT) contour plots of Li—S coin cells across the depth of discharge for the baseline with 0.01 M MS⁻.

FIG. 14e shows operando raman contour plots of Li—S coin cells across the depth of discharge for the baseline with 0.01 M TFMS⁻, where the operando Raman is plotted alongside the discharge profile, highlighting the voltage at which the polysulfides are formed.

FIG. 14f shows the distribution of relaxation times (DRT) contour plots of Li—S coin cells across the depth of discharge for the baseline with 0.01 M TFMS⁻.

FIG. 15a shows optical images of 0.01 M, 0.05 M, and 0.1 M trifluoro-methanesulfonate (TFMS⁻) in 1,3-dioxolane (DOL), showing its polymerization into p-DOL.

FIG. 15b shows Fourier transform infrared spectroscopy (FTIR) of 1,3-dioxolane (DOL) (pink), trifluoro-methanesulfonate (TFMS⁻) (blue), and p-DOL (green).

FIG. 15c shows Nuclear magnetic resonance (NMR) spectra of 1,3-dioxolane (DOL) (pink), trifluoro-methanesulfonate (TFMS⁻) (blue), and p-DOL (green).

FIG. 15d is a schematic illustrating the polymerization of 1,3-dioxolane (DOL) induced by interactions with trifluoro-methanesulfonate (TFMS⁻).

FIG. 15e shows SEM micrographs of Li-metal surfaces harvested from Li—S coin cells after the first cycle at C/20, from left to right: pristine, baseline, 0.01 M trifluoro-methanesulfonate (TFMS⁻), and 0.01 M methanesulfonate (MS⁻).

FIG. 15f shows Li-metal plating and stripping tests using 1 mAh/cm² areal capacity at 1 mA/cm² current density.

FIG. 15g is a schematic showing the role of p-DOL in forming a stable and thick anode interfacial layer.

FIG. 16a shows SEM micrographs of the Li metal surface after 300 cycles in Li—S coin cells with baseline electrolyte, 0.01 M methanesulfonate (MS⁻), and 0.01 M trifluoro-methanesulfonate (TFMS⁻) additives (left to right), highlighting the influence of additive chemistry on surface morphology and Solid Electrolyte Interphase (SEI) formation.

FIG. 16b shows schematic representation of the electron-induced radical polymerization of 1,3-dioxolane (DOL) into polymerized DOL (p-DOL).

FIG. 16c shows proposed mechanistic pathways illustrating the distinct roles of trifluoro-methanesulfonate (TFMS⁻) and methanesulfonate (MS⁻) in modulating interfacial chemistry and Li⁺ solvation, promoting polymer formation, and stabilizing the anode-electrolyte interface.

### DETAILED DESCRIPTION

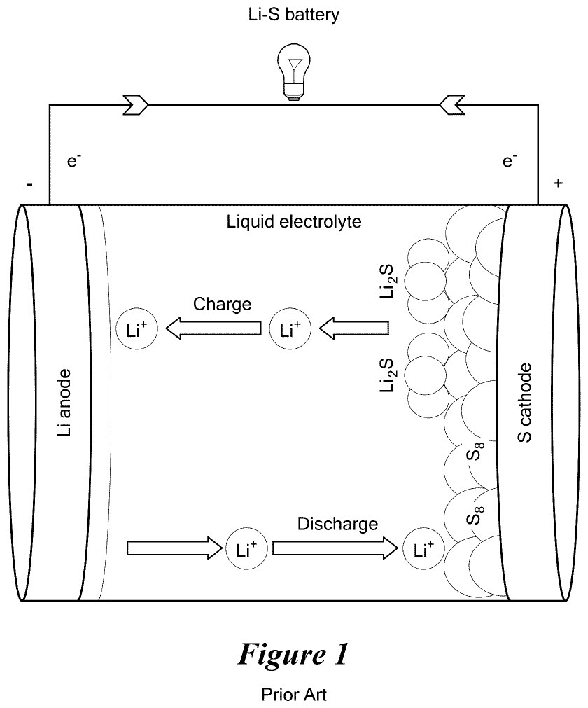

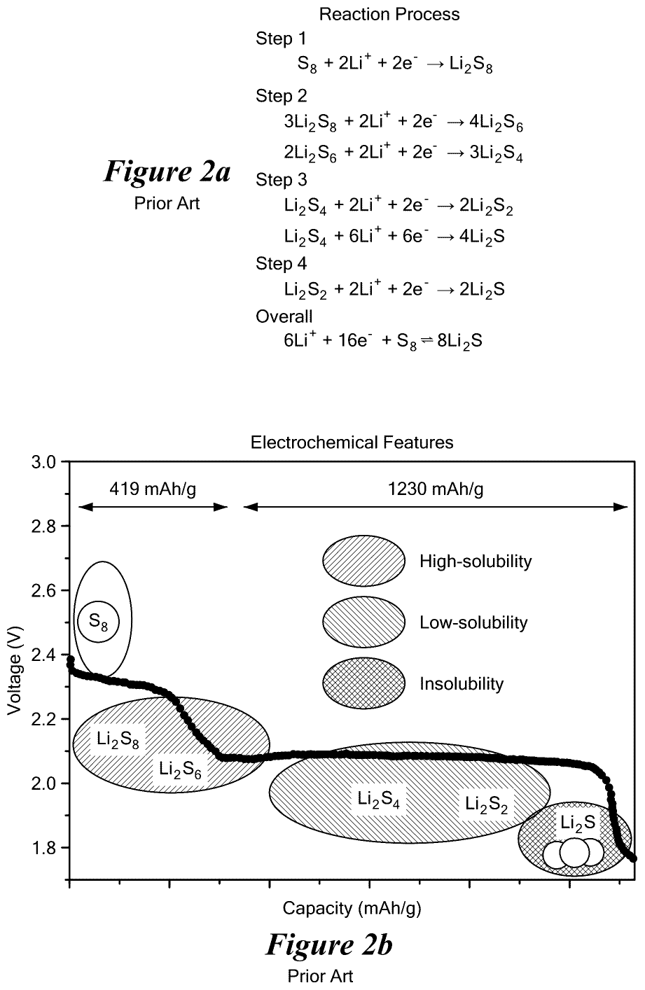

The present technology provides a family of compounds, both with and without organosulfur anions, capable of serving as catalysts for lithium-sulfur (Li—S) batteries. FIG. 1 shows a schematic illustration of a Li—S battery. Cathode issues in Li—S batteries include low conductivity of S/Li₂S, volume change from S to Li₂S, shuttle effect, and sluggish redox kinetics. Electrolyte issues in Li—S batteries include low mechanical toughness, high flammability, and polysulfide shuttle. Anode issues in Li—S batteries include formation of Li dendrites, volume change from Li to Li·, unstable Solid Electrolyte Interphase (SEI), and high chemical reactivity. FIG. 2a shows that reactions which result in the formation of various lithium sulfur compounds and FIG. 2b shows the electrochemical features of such compounds and octasulfur including voltage versus capacity.

Tetrabutylammonium (TBA)-based compounds exhibit solubility in conventional Li—S battery electrolytes. Incorporating them into the liquid electrolyte yields enhanced cell performance. This breakthrough presents promising avenues for future research and development endeavors within this domain.

These catalysts have demonstrated a substantial enhancement in cycling performance, evidenced by improvements of up to 52% observed after 50 cycles at C/5 (5 hours of charge and 5 hours of discharge), coupled with a notable coulombic efficiency of 98%. The introduction of this innovative family of catalysts paves the way for further optimization of Li—S batteries, propelling them closer to practical implementation in electric vehicles applications.

The present technology provides tetrabutylammonium-based (TBA⁺) salts with known and novel anions—trifluoro-methanesulfonate (TFMS⁻) and methanesulfonate (MS⁻). In electrochemistry, their role has ranged from enhancing performance of lead-acid batteries, anodic stability in magnesium batteries to Li—S batteries using high concentration electrolytes (HCEs) Ref. 2 [31-33]. To investigate their impact on low concentration electrolyte (LCE) systems and gain deeper understanding of the role of the anions without adding Li⁺, ⁷Li-NMR, density functional theory (DFT) and ab-initio molecular dynamics simulations were employed to probe the solvation effects and structures. The additives' interactions with LiPs through Li₂S₆ catholyte symmetric cells, Li₂S nucleation studies, ex-situ ⁷Li and ¹⁹F NMR characterization and the Galvanostatic Intermittent Titration Technique (GITT) were investigated. For probing the impact on the anode and electrolyte, the electrochemical stability window was assessed, followed by cyclic voltammetry and extensive in-situ Electrochemical Impedance Spectroscopy (EIS) with activation energy calculations. The improvement in performance was demonstrated through rate studies and long-term cycling at C/2 and 1C. Next, Operando Raman spectroscopy coupled with Distribution of Relaxation Times (DRT) analysis was employed to shed light on reaction pathways, rates and intermediates formed during cycling. Finally, Li metal plating and stripping including electrochemical Li deposition on the surface from Li-ion form to Li0 form, and then electrochemically scalping the Li from the surface from Li0 to Li-ion, repeated hundreds of times to validate the interfacial stability at different electrolyte system, and Scanning Electron Microscopy (SEM) analysis of cycled anodes are conducted to probe the impact on Solid Electrolyte Interphase (SEI) formation. Meanwhile Fourier transform infrared spectroscopy (FTIR) and 13C Nuclear magnetic resonance (NMR) reveal details of the additive-solvent interactions. Demonstrating the TBA⁺ cation as being compatible with Li—S system enables further exploration and design of anions to address the limitations of this battery system, accelerating their commercialization.

The present catalysts can be used in Li—S batteries for many purposes, for example, batteries for grid power storage, for electrification of transportation, as an alternative for other battery types (e.g., lead acid, alkaline, carbon zinc), deep sea mining, and for offshore oil and gas operations.

### EXAMPLES

### Example 1: Preparation and Testing of Catalysts for Coin Cell Li—S Batteries

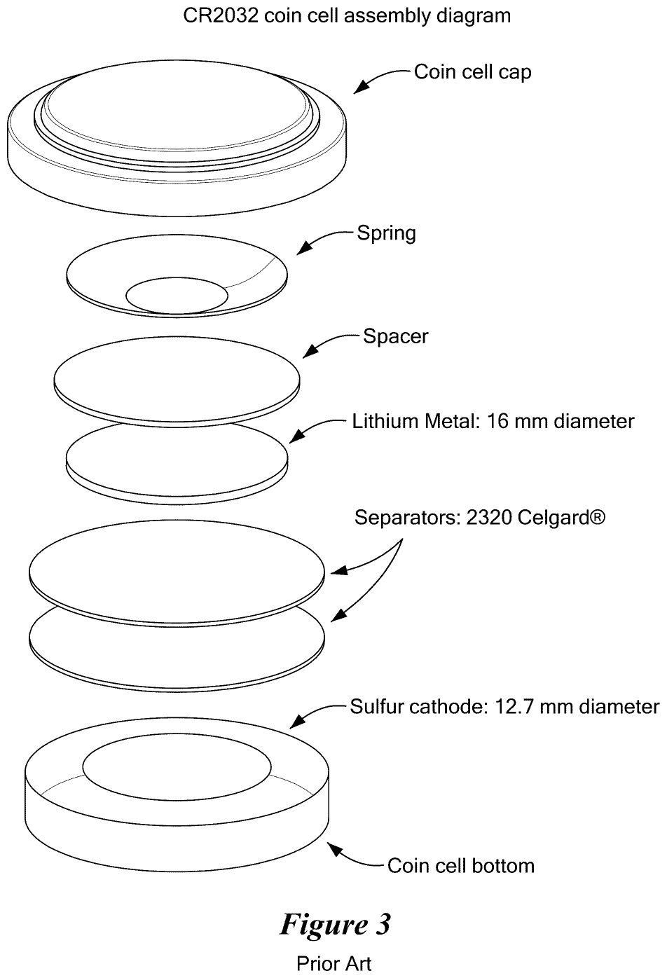

Cathode preparation: First, a binder was formed by mixing polyvinylidene fluoride (PVDF) with N-methylpyrrolidone (NMP) at a 1:9 weight ratio. Next, carbon black, sulfur and more NMP were added to form the cathode slurry. Then, the slurry was coated using a doctor blade onto a conductive carbon-coated aluminum foil (18 μm thick). Lastly, the cathode was dried overnight at 90° C. The final cathode composition was 52% sulfur, 38% carbon black, and 10% PVDF.
Liquid electrolyte preparation: 1 M of Lithium bis(trifluoromethane)sulfonimide (LiTFSI) and 0.1 M of Lithium nitrate (LiNO3) were dissolved in a mixture of 1,2-dimethoxyethane (DME) and 1,3-dioxolane (DOL) at 1:1 volume ratio, in an argon-filled glovebox. This mixture formed the baseline electrolyte. Next, tetrabutylammonium (TBA)-based compounds were added to the electrolyte and the electrolyte was placed on a hotplate at 70° C. to speed up the dissolution of the catalysts. The amount of catalyst varied from 0.01 to 0.25 M, and up to 5 weight percent.
Coin cell assembly: A stainless steel coin cell (CR2032) was assembled inside an argon-filled glovebox using a Li metal anode (16 mm diameter), 2 layers of separator (2320 Celgard®), and the sulfur cathode (12.7 mm diameter. The cathode possessed an average sulfur loading of 1.78 mg/cm². The volume of electrolyte added to the coin cell was in the range of 50-70 μL. Finally, the coin cell was sealed using a crimper with a pressure ranging from 5 to 7 MPa. A diagram including a schematic illustration of the coin-cell can be found in FIG. 3.

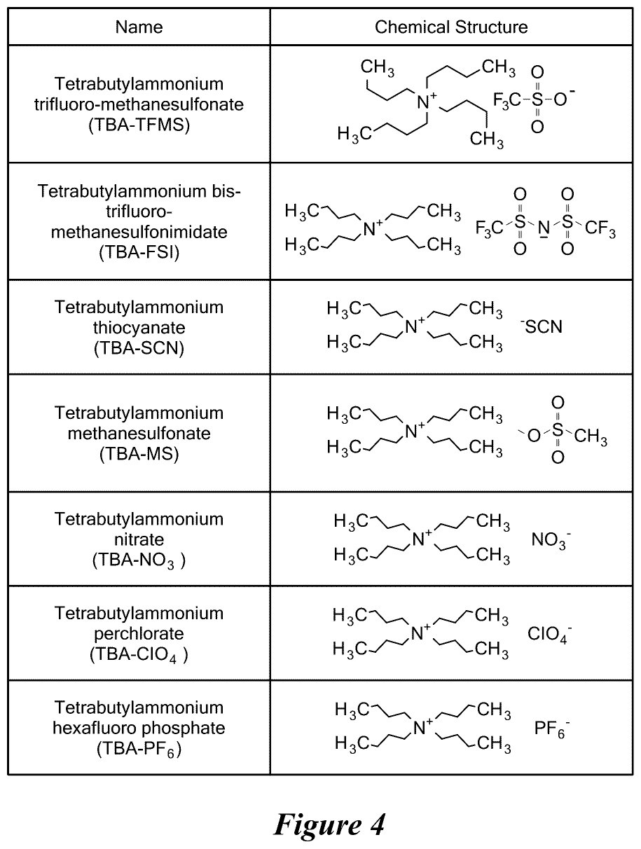

Below is the list of the Tetrabutylammonium (TBA)-based catalysts tested in this application.
1. Tetrabutylammonium trifluoro-methanesulfonate (TBA-TFMS)
2. Tetrabutylammonium bis-trifluoro-methanesulfonimidate (TBA-FSI)
3. Tetrabutylammonium hexafluoro phosphate (TBA-PF₆)
4. Tetrabutylammonium nitrate (TBA-NO₃)
5. Tetrabutylammonium perchlorate (TBA-ClO₄)
6. Tetrabutylammonium thiocyanate (TBA-SCN)
7. Tetrabutylammonium methanesulfonate (TBA-MS)
   FIG. 4 shows schematics of the chemical structures of the Tetrabutylammonium (TBA)-based catalysts tested.
   Coin cell testing: The coin cells were tested using an Arbin battery tester model BT-2143. For long-term cycling, they initially underwent a stabilization cycle comprising 3 cycles at a C-rate of C/20 followed by 3 cycles at a C-rate of C/10, before continuing with the remaining cycles at a C-rate of C/5. In the rate capability test, the coin cells were cycled at various C-rates (C/20, C/10, C/5, C/2, 1C, and back to C/10), each lasting five cycles, except that the final C-rate of C/10 was sustained for an additional 10 cycles. For the cycling voltammetry study, the scan rate ranged from 0.1 to 1 mV/s with 0.1 mV/s increment. The voltage window for all the experiments was set from 1.5 to 2.8 V vs. Li⁰/Li⁺.

### Example 2: Rate Capability Including Discharge Capacity at Distinct C-Rates for Coin Cells Containing Electrolyte at Different Tetrabutylammonium Bis-Trifluoro-Methanesulfonimidate (TBA-FSI) Additive Concentrations in Comparison with Coin Cells Containing Baseline Electrolyte Containing No Catalyst

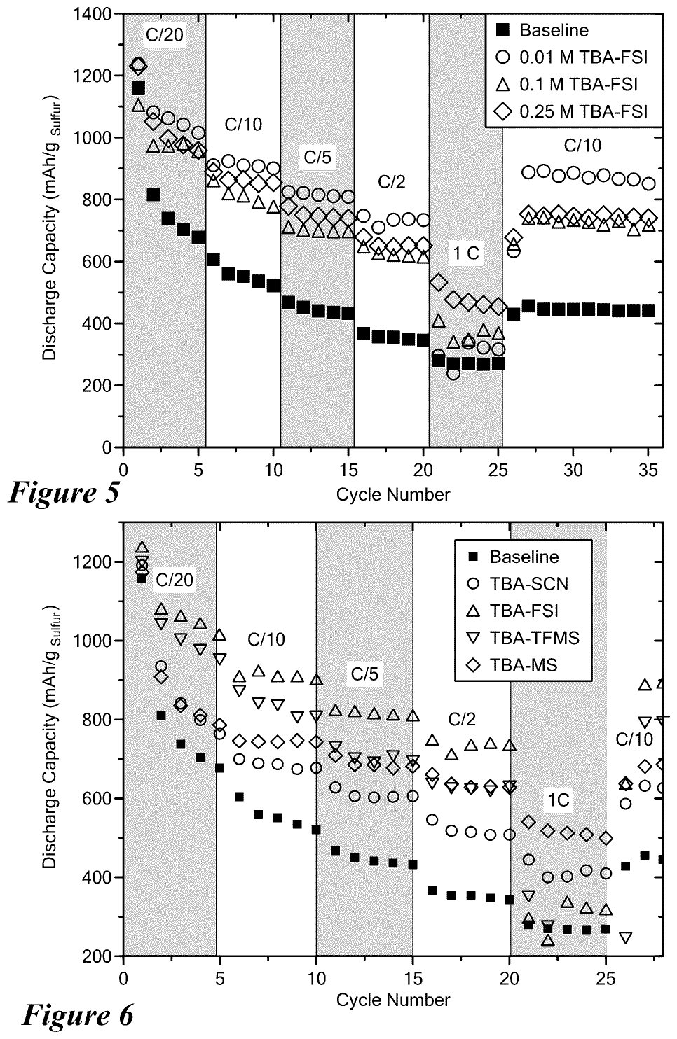

Rate capability studies including discharge capacity were performed to validate the catalytic nature of the catalysts. In FIG. 5, coin cells containing electrolyte containing 0.01 M, 0.1 M, and 0.25 M of Tetrabutylammonium bis-trifluoro-methanesulfonimidate (TBA-FSI) were cycled at distinct C-rates, and the results were compared to coin cells containing the baseline electrolyte containing no catalyst at the corresponding C-rates. At an initial C-rate of C/20 (20 hours to charge and discharge), the coin cells containing the catalyst exhibited a slower rate of capacity decrease than the coin cells containing the baseline electrolyte containing no catalyst. As the cycling continued to C-rate of C/2 (2 hours to charge and 2 hours to discharge), all the coin cells containing the catalyst-containing electrolytes showed a capacity improvement ranging from 44% to 53% compared to the coin cell containing the baseline electrolyte containing no catalyst. Moreover, when changing the cycling rate from a C-rate of 1C to C/10, the coin cells containing the catalyst-containing electrolytes displayed a higher capacity recovery than the coin cells containing the baseline electrolyte, with an overall higher capacity of more than 40%.

### Example 3: Rate Capability Study Including Discharge Capacity at Distinct C-Rates for Coin Cells Containing Electrolytes Containing Various Catalysts in Comparison with Coin Cell Containing Baseline Electrolyte Containing No Catalyst

In FIG. 6, coin cells containing electrolytes containing 0.01 M of Tetrabutylammonium thiocyanate (TBA-SCN), 0.01 M of Tetrabutylammonium bis-trifluoro-methanesulfonimidate (TBA-FSI), 0.01 M of Tetrabutylammonium trifluoro-methanesulfonate (TBA-TFMS), and 0.01 M of Tetrabutylammonium methanesulfonate (TBA-MS) were cycled at distinct C-rates, and the results were compared to the coin cells containing baseline electrolyte containing no catalyst cycling at the corresponding C-rates. Trends similar to the coin cell containing electrolyte containing Tetrabutylammonium bis-trifluoro-methanesulfonimidate (TBA-FSI) were observed in the coin cells containing electrolytes containing the other catalysts, such as Tetrabutylammonium trifluoro-methanesulfonate (TBA-TFMS), Tetrabutylammonium methanesulfonate (TBA-MS), and

Tetrabutylammonium thiocyanate (TBA-SCN), all of which possessed higher capacity than the coin cell containing the baseline electrolyte containing no catalyst (FIG. 6). These results demonstrate that Tetrabutylammonium (TBA)-based compounds serve as catalysts by enhancing the system's ability to be cycled at high rates.

### Example 4: Long-Term Cycling Performance Data Including Discharge Capacity at Distinct C-Rates for Coin Cells Containing Electrolytes Containing Various Catalysts in Comparison with Coin Cells Containing Baseline Electrolyte Containing No Catalyst

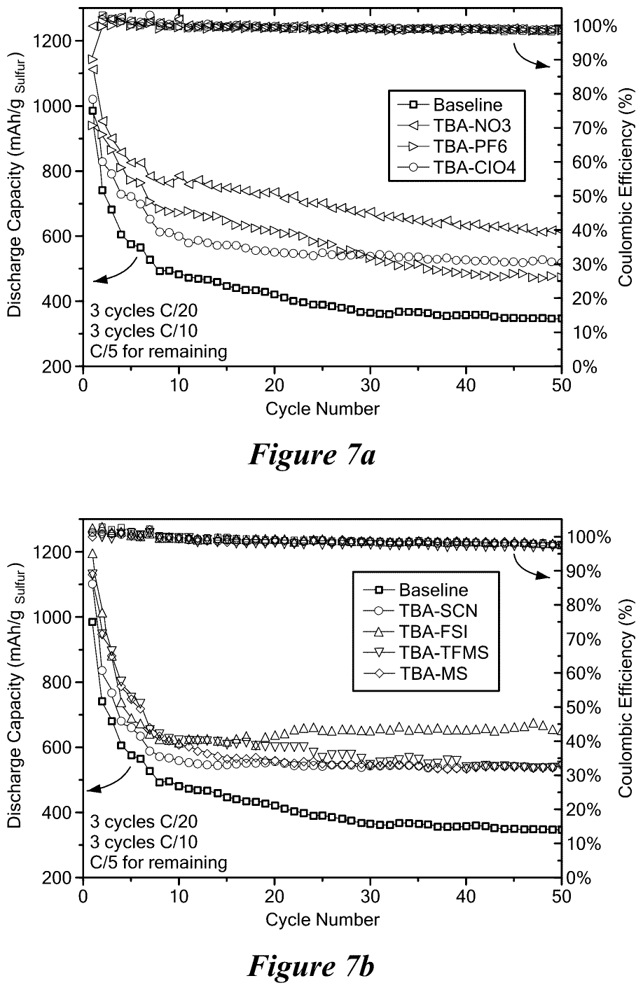

Furthermore, a comprehensive evaluation of long-term cycling performance was conducted to elucidate the influence of the catalysts. FIG. 7a shows long-term cycling performance data including discharge capacity at distinct C-rates for coin cells containing electrolyte containing catalyst versus coin cells containing baseline electrolyte containing no catalyst. Three different types of catalyst containing electrolyte were tested: up to 5 wt. % of each of Tetrabutylammonium nitrate (TBA-NO₃), Tetrabutylammonium hexafluoro phosphate (TBA-PF₆) and Tetrabutylammonium perchlorate (TBA-ClO₄) of the total electrolyte (60 μL).

FIG. 7b also shows long-term cycling performance data including discharge capacity at distinct C-rates for coin cells containing electrolyte containing catalyst versus coin cells containing baseline electrolyte containing no catalyst. Three different types of catalyst containing electrolyte were tested: 0.01M of Tetrabutylammonium thiocyanate (TBA-SCN), 0.01M of Tetrabutylammonium bis-trifluoro-methanesulfonimidate (TBA-FSI), and 0.01M of Tetrabutylammonium trifluoro-methanesulfonate (TBA-TFMS) catalyst. Similar to the baseline electrolyte containing no catalyst, all coin cells containing catalyst-containing electrolytes demonstrated an initial capacity decline followed by a steady-state region (FIGS. 6A and 6B). Notably, all samples of coin cells having electrolyte containing the catalysts exhibited superior capacity retention and achieved a steady state more expeditiously compared to the coin cells having baseline electrolyte containing no catalyst. These results suggest the potential of Tetrabutylammonium (TBA)-based compounds to serve as effective polysulfide anchors. Review of FIGS. 4, 5 and 6A and 6B show a 44% to 53% discharge capacity performance improvement for coin cells containing Tetrabutylammonium (TBA)-based catalyst containing electrolyte in comparison with coin cells containing baseline electrolyte containing no catalase.

### Example 5: Cyclic Voltammetry Diagrams for Coin Cells Containing Electrolytes Containing Various Catalysts Versus Coin Cell Containing Baseline Electrolyte Containing No Catalyst

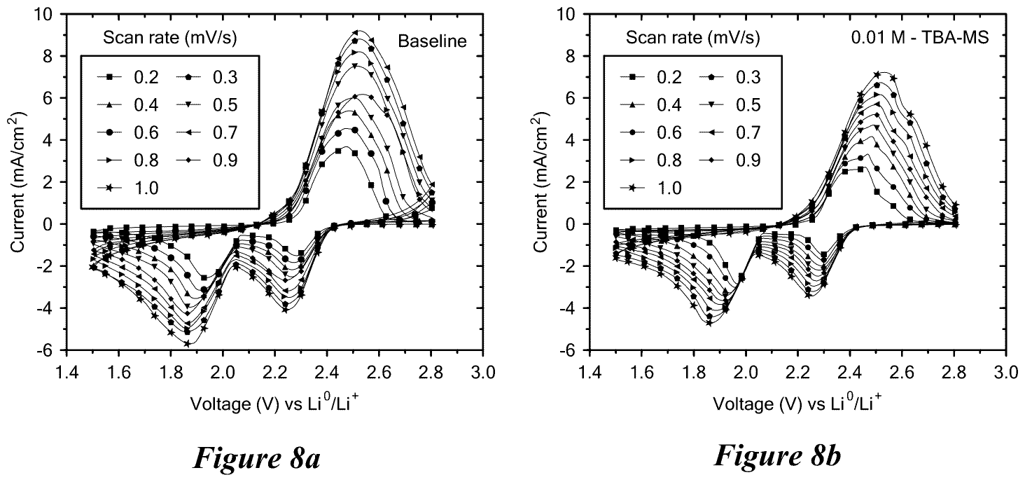

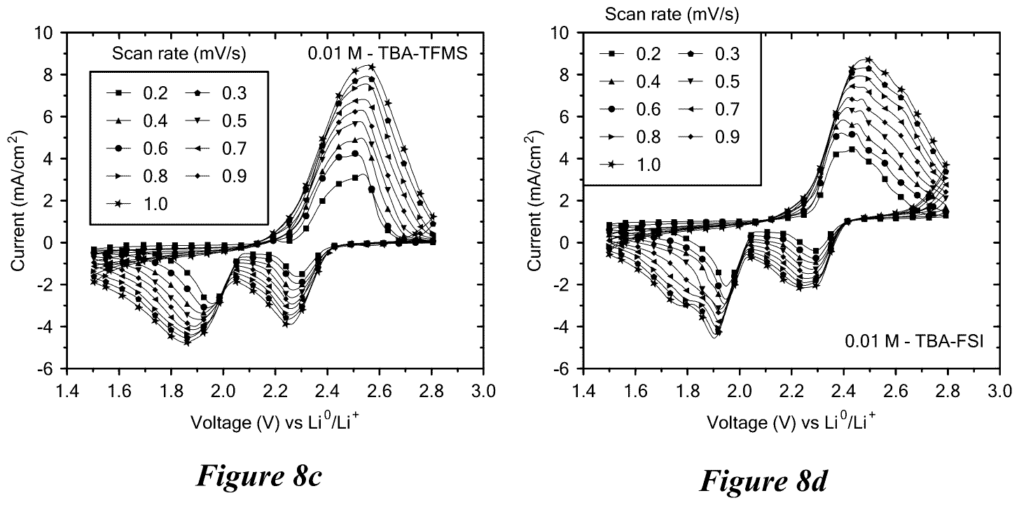

For a more comprehensive understanding of the impact of the catalysts on the redox pathway of the Li—S battery, cyclic voltammetry experiments were conducted. FIGS. 7a-7D depict the cyclic voltammetry profiles of coin cells including respectively baseline electrolyte with no catalyst (FIG. 8a), electrolyte containing 0.01M of Tetrabutylammonium methanesulfonate (TBA-MS) (FIG. 8b), electrolyte containing 0.01M of Tetrabutylammonium trifluoro-methanesulfonate (TBA-TFMS) (FIG. 8c), and a electrolyte containing 0.01 M of Tetrabutylammonium bis-trifluoro-methanesulfonimidate (TBA-FSI) (FIG. 8d). Upon the addition of 0.01M of Tetrabutylammonium trifluoro-methanesulfonate (TBA-TFMS) and Tetrabutylammonium methanesulfonate (TBA-MS) (FIGS. 8b and 8c, respectively), no additional peaks were observed. However, the introduction of Tetrabutylammonium bis-trifluoro-methanesulfonimidate) TBA-FSI yielded an anodic peak at approximately 1.75 V vs. Li⁰/Li⁺ (FIG. 8d), indicating the electrochemical activity of Tetrabutylammonium bis-trifluoro-methanesulfonimidate (TBA-FSI) and its distinct catalytic pathway compared to Tetrabutylammonium trifluoro-methanesulfonate (TBA-TFMS) and Tetrabutylammonium methanesulfonate (TBA-MS). This observation further underscores the unique attributes of TBA-based compounds.

### Example 6: Examination of Impact of the Catalyst on the Li-Ion Diffusion Coefficient Using Cyclic Voltammetry and the Randles Sevcik Equation for Reversible Systems at 25° C.

Additionally, the impact of the catalyst on the Li-ion diffusion coefficient was examined using cyclic voltammetry and the Randles Sevcik equation for reversible systems at 25° C., found below:

$${I}_{p} = 268 , 000 \times {n}^{\frac{3}{2}} \times A \times {D}_{{Li}^{+}}^{\frac{1}{2}} \times {C}_{{Li}^{+}} \times {v}^{\frac{1}{2}}$$

in which Iₚ represents the peak current, A is the electrode surface area, C_{Li+} is the concentration of the Li-ion in the electrolyte, D_{Li+} is the diffusion coefficient of Li-ion, n represents the number of electrons, and v is the scan rate.

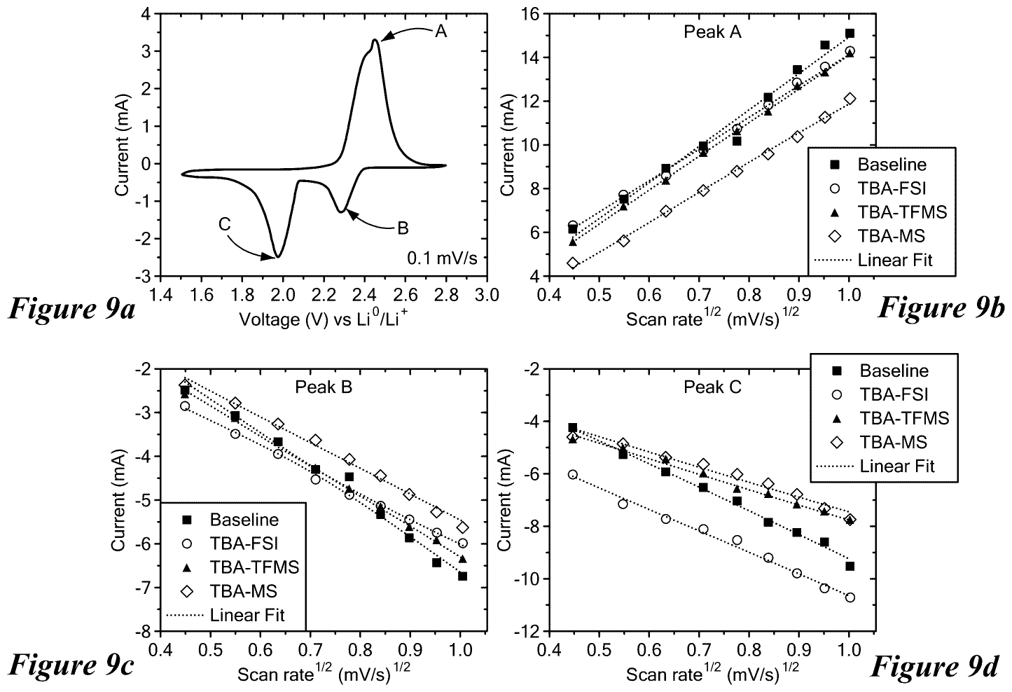

FIG. 9a shows the Randles Sevcik study for the cyclic voltammetry profile of baseline electrolyte with reduction peak (A) and oxidation peaks (B and C). FIGS. 9b, 9c, and 9d show the linear relationship between the current versus the square root of the scan rate for reduction peak A, oxidation peak B and oxidation peak C for baseline electrolyte containing no catalyst and electrolytes containing catalyst. The slope of the line is directly proportional to the D_{Li+}.

Table 3 shows the slope values of the current versus the square root of the scan rate based on Randle-Sevcik analysis found in FIGS. 8a-D and 9a-D for coin cells containing the baseline electrolyte containing no catalyst and for coin cells containing 0.01 M of TBA-TFMS. TBA-FSI, and TBA-MS-containing electrolytes.

TABLE 3
Slope values of current versus the square root of the
scan rate based on Randle-Sevcik analysis found in
FIGS. 5 and 6 for baseline electrolyte and 0.01M of
TBA-TFMS, TBA-FSI, and TBA-MS-containing electrolytes

| | | |
|---|---|---|
| Sample | Slope | R-square |

Peak A

| | | |
|---|---|---|
| Baselike | 16.646 | 0.981 |
| TBA-TFMS | 15.530 | 0.999 |
| TBA-FSI | 14.655 | 0.966 |
| TBA-MS | 13.575 | 0997 |

Peak B

| | | |
|---|---|---|
| Baseline | −7.882 | 0.985 |
| TBA-TFMS | −6.889 | 0.998 |
| TBA-FSI | −5.661 | 0.052 |
| TBA-MS | −5.972 | 0.992 |

Peak C

| | | |
|---|---|---|
| Baseline | −9.039 | 0.993 |
| TBA-TFMS | −5.821 | 0.991 |
| TBA-FS1 | −8.212 | 0.990 |
| TBA-MS | −5.620 | 0.970 |

Based on the results shown above in Table 3, the baseline electrolyte has a higher value for the slope, indicating slightly higher Li-ion diffusion. The slight deceleration of Li-ion diffusion may allow for a higher conversion of polysulfides, further proving the role of TBA-based compounds as catalysts for Li—S batteries.

### Example 7: First Charge and Discharge Profiles

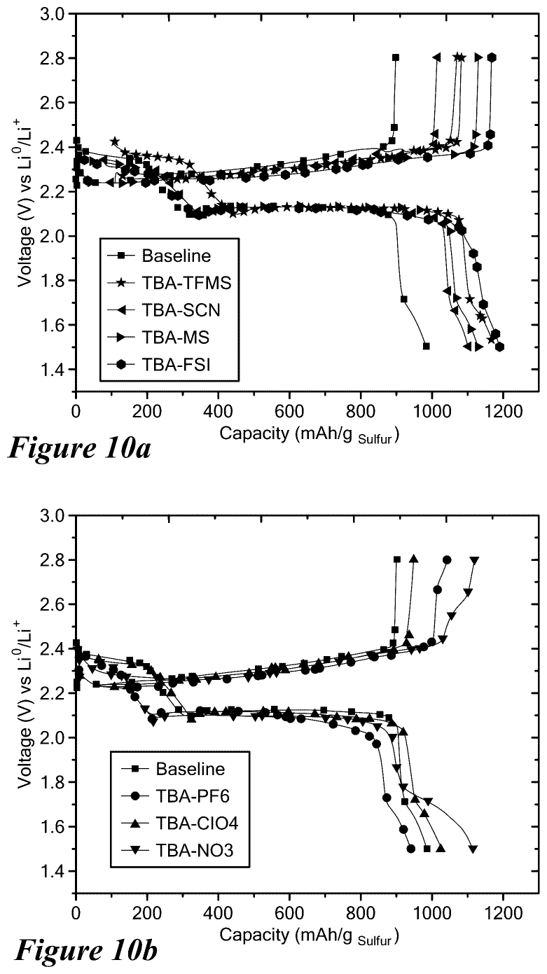

First charge and discharge profiles versus baseline electrolyte are shown for coin cells containing electrolyte with catalysts in comparison with baseline electrolyte containing no catalyst. FIG. 10a shows the first charge and discharge profiles for coin cells containing electrolyte containing respectively 0.01M of Tetrabutylammonium thiocyanate (TBA-SCN), 0.01M Tetrabutylammonium bis-trifluoro-methanesulfonimidate (TBA-FSI) electrolyte, and 0.01M Tetrabutylammonium trifluoro-methanesulfonate (TBA-TFMS), in comparison with coin cells containing baseline electrolyte containing no catalyst. FIG. 10b shows first charge and discharge profiles for coin cells containing electrolyte containing respectively 5 wt. % of Tetrabutylammonium nitrate (TBA-NO₃), 5 wt. % of Tetrabutylammonium hexafluoro phosphate (TBA-PF₆), and 5 wt. % of Tetrabutylammonium perchlorate (TBA-ClO₄) electrolyte, in comparison with baseline electrolyte containing no catalyst.

### Example 8: Li-Ion Interactions and Complexation

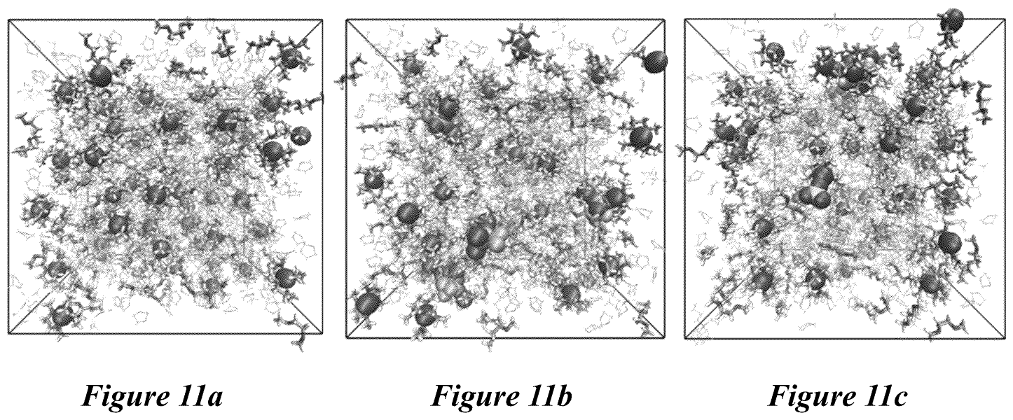

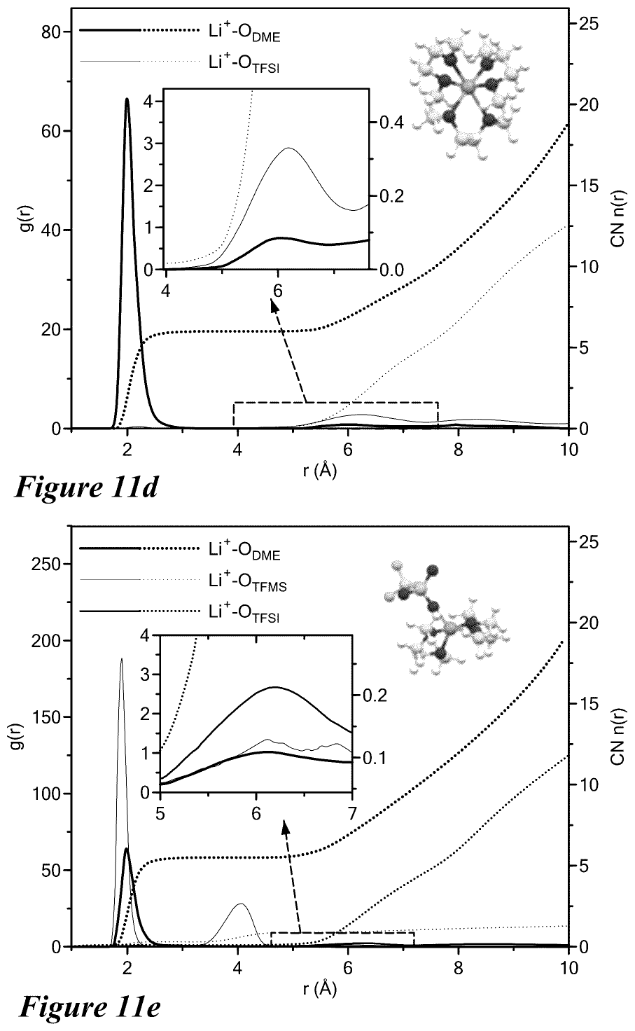

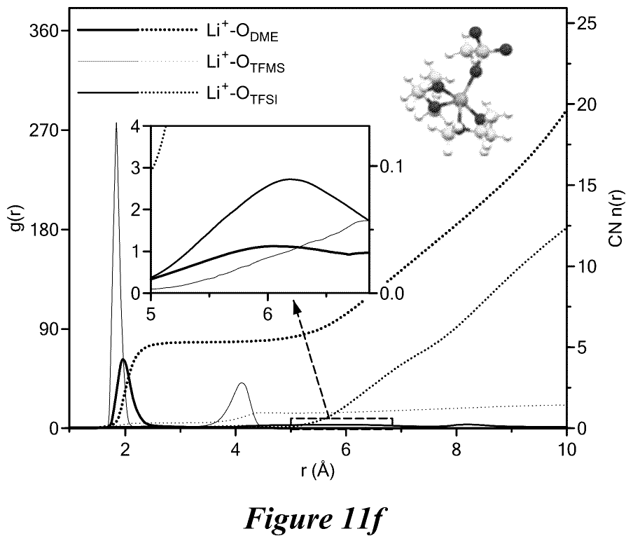

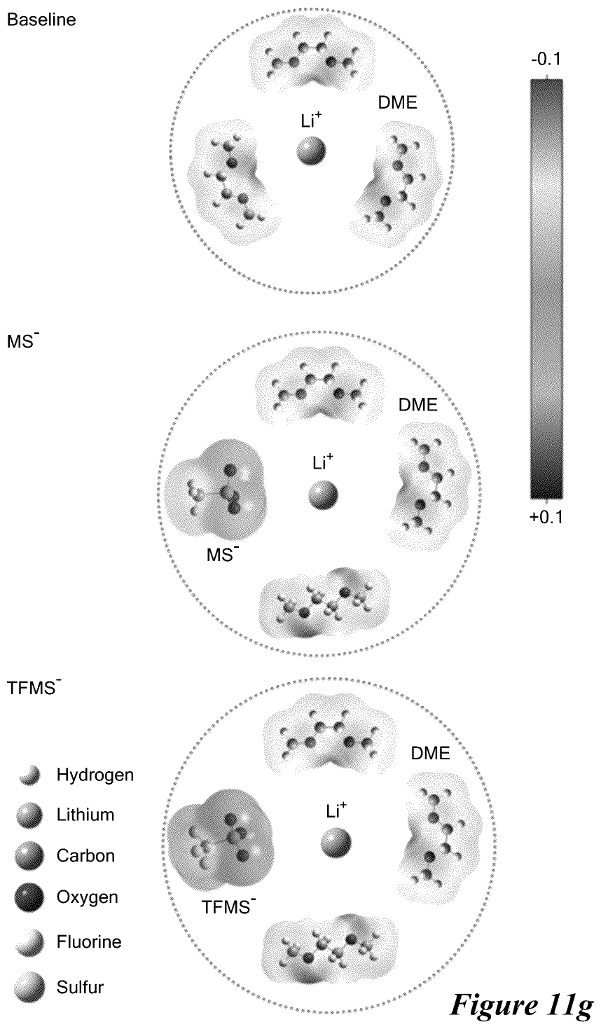

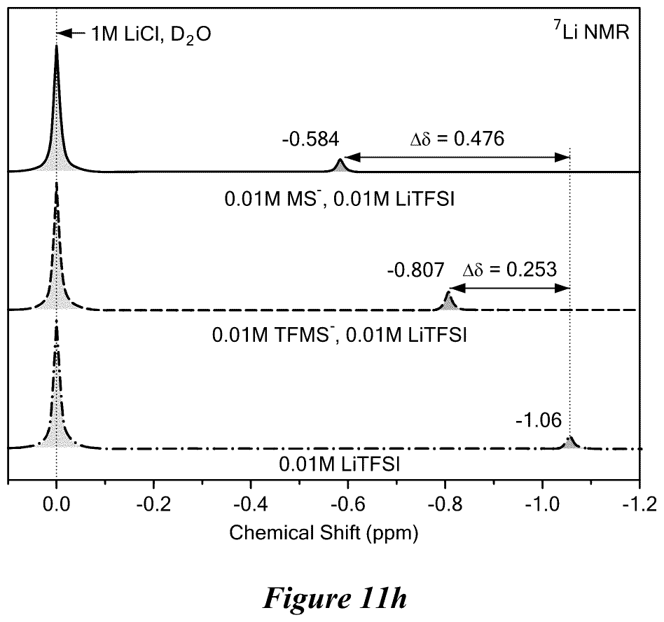

The effect of additive anions on the lithium-ion solvation environment was systematically examined through molecular dynamics (MD) simulations. Three representative electrolyte systems were modeled: a baseline formulation consisting of 1.0 M[S] LiTFSI in DOL/DME (1:1 by volume), and two variants incorporating 0.1 M[S] TFMS or 0.1 M[S] MS). Analysis of the coordination number (CN) profile for DME around Li⁺ revealed a well-defined plateau between 2.7 Å and 5.3 Å, which defines the inner solvation shell or first solvation sheath (FIG. 11a, 11d). Ref. 2 [24]. In the baseline electrolyte, the DME exhibits a CN around 6, while in the presence of TFMS or MS, it decreases to around 5.5. Since CN is defined by the interaction between Li⁺ and oxygen atoms in DME, this reduction clearly indicates that the additives disrupt the original solvation structure of inner shell by lowering the solvating power of DME.

Moreover, both additives introduce a new, weaker coordination interaction between Li⁺ and the oxygen in additive anions. In the TFMS-containing system, a secondary CN feature emerges between 2.38 and 3.13 Å with a value of 0.287, while in the MS system, a CN of 0.32 appears between 2.18 and 3.23 Å (FIG. 11b, c, FIG. 11c, 11f). These distances fall within the inner solvation shell of Li⁺, indicating that the additive anions partially enter the coordination environment and contribute to restructuring the solvation shell.

The observed reduction in DME coordination number is expected to lower the Li⁺ de-solvation energy barrier—a key factor in facilitating sulfur redox reactions (SRR). This hypothesis is supported by ⁷Li NMR spectroscopy, which shows a downfield chemical shift in the presence of TFMS and MS (FIG. 11h), indicating a more de-shielded and weakly coordinated lithium environment.

DME typically coordinates with Li⁺ through bidentate chelation. However, the oxygen atoms in the additive anions can also interact with Li⁺, competing with DME for coordination sites within the inner solvation shell. Density functional theory (DFT) calculations support this competitive interaction: the calculated exchange energy for forming Li(DME) ₂(MS) is −0.23 eV, and −0.11 eV for Li(DME) ₂(TFMS), relative to the reference Li(DME)₃ cluster (0 eV). These values confirm that additive anions might partially replace DME in the inner solvation shell, thereby weakening DME's coordination strength. As a result, fewer oxygens in DME molecules remain bound to Li⁺, lowering the energy barrier for de-solvation and promoting more efficient Li⁺ transport during the SRR.

To validate these observations, quantum mechanical (QM) calculations were performed on the most populated Li⁺ solvation structures identified by molecular dynamics simulations. The calculated isotropic shielding constants reflect a consistent trend with experimental data: Li(DME)₃ exhibits the most negative shift (strongest shielding), followed by Li(DME)₂ (TFMS) and Li(DME)₂ (MS), with computed values of −0.210 ppm, −0.082 ppm, and 0.000 ppm, respectively (Table 4). This indicates that introducing MS or TFMS into the solvation shell results in a less shielded Li⁺ environment compared to the baseline. Notably, replacing a DME molecule with a TFSI-anion leads to a much larger de-shielding effect, which aligns with both the experimental spectra and the MD simulations suggesting a negligible population of Li (DME) 2 (TFSI) complexes.

The shielding constants also show a strong dependence on the Li—O bond length, underscoring the role of local coordination geometry in shaping the Li⁺ electronic environment. In the Li(DME)₂(L) complexes (L=MS or TFMS), Li—O (MS) has a bond length of 1.880 Å and a calculated shielding of 92.164 ppm, whereas the longer Li—O (TFMS) bond at 1.945 Å results in slightly increased shielding of 92.246 ppm. This inverse relationship—shorter Li—O bonds yielding lower shielding—is consistent across coordination motifs.

TABLE 4
Isotropic shielding and isotropic shift
(unit: ppm) of ⁷Li relative complexes

| | Ave. Isotropic | R_{Li—O}(add.) | Δ Isotropic chemical |
|---|---|---|---|
| Complex | shielding (ppm) | (Å) | shift (ppm) |
| Li(DME)₂(MS)^{a} | 92.164 | 1.880 | 0.000 |
| Li(DME)₂(TFMS)^{a} | 92.246 | 1.945 | 0.082 |
| Li(DME)₃ | 92.554 | | −0.390 |
| Li(DME)₂(TFSI) | 91.954 | | 0.210 |

In summary, the addition of TFMS and MS modifies the lithium-ion solvation structure not by acting as inner-shell ligands, but by serving as peripheral coordination modifiers. Rather than displacing DME from the primary solvation shell, these anions subtly reshape the local coordination environment, leading to a reduced number of DME molecules directly bound to Li⁺. This structural adjustment explains the distinct ⁷Li NMR chemical shifts observed in the presence of these additives. Crucially, because TFMS and MS reside near the boundary of the Li⁺ solvation shell without fully bonding to it, they remain accessible for interfacial redox reactions. Their positioning increases the likelihood of electrochemical reduction or oxidation at the electrode surface, potentially contributing to the formation of a more stable solid electrolyte interphase (SEI) or cathode electrolyte interphase (CEI).

### Example 9: Polysulfides Interactions and Complexations

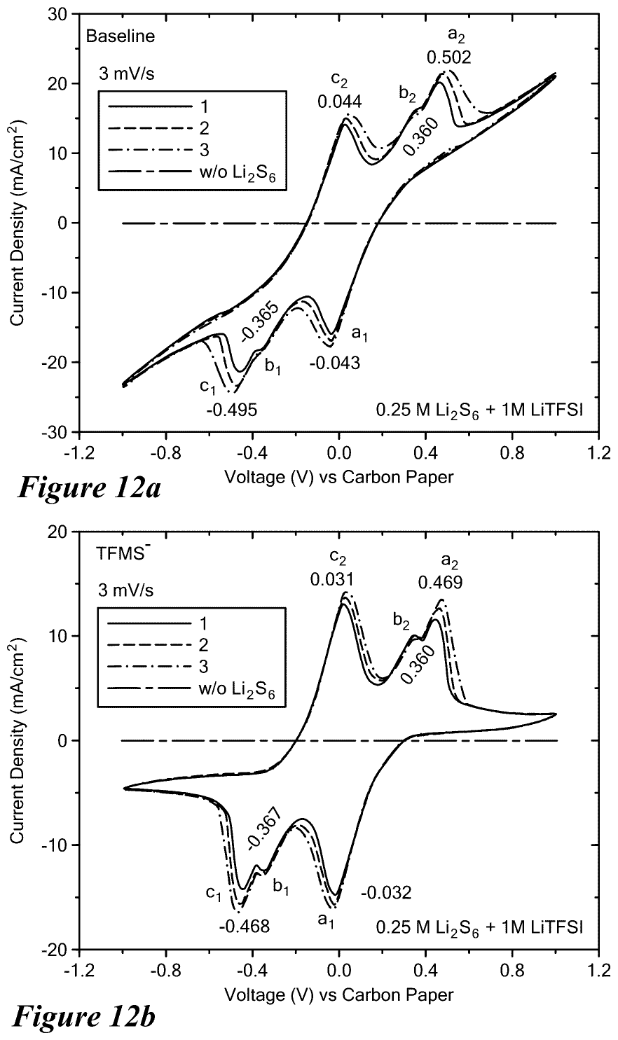

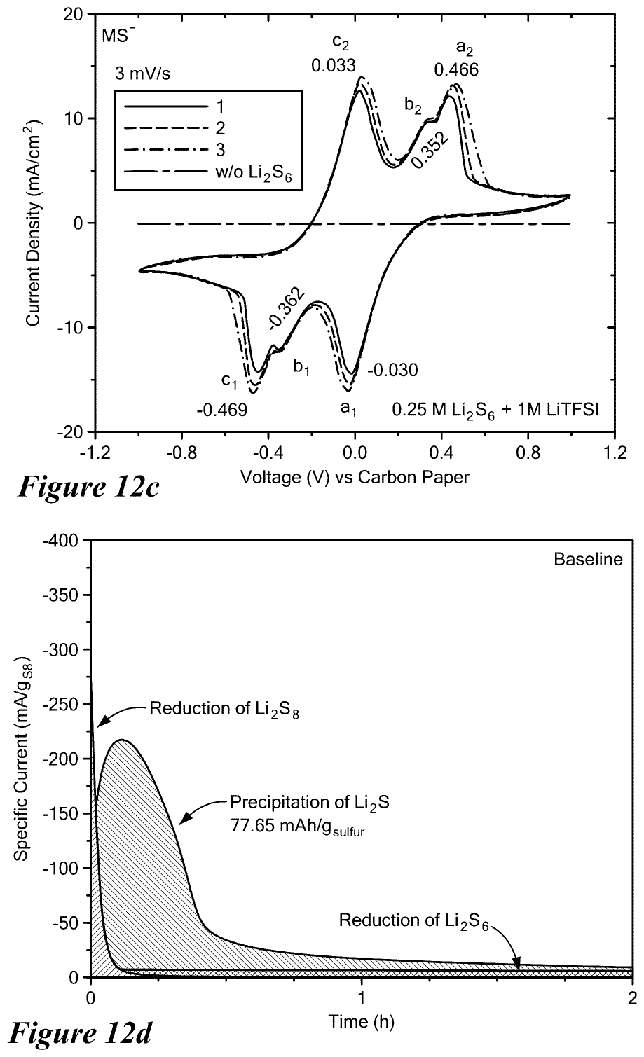

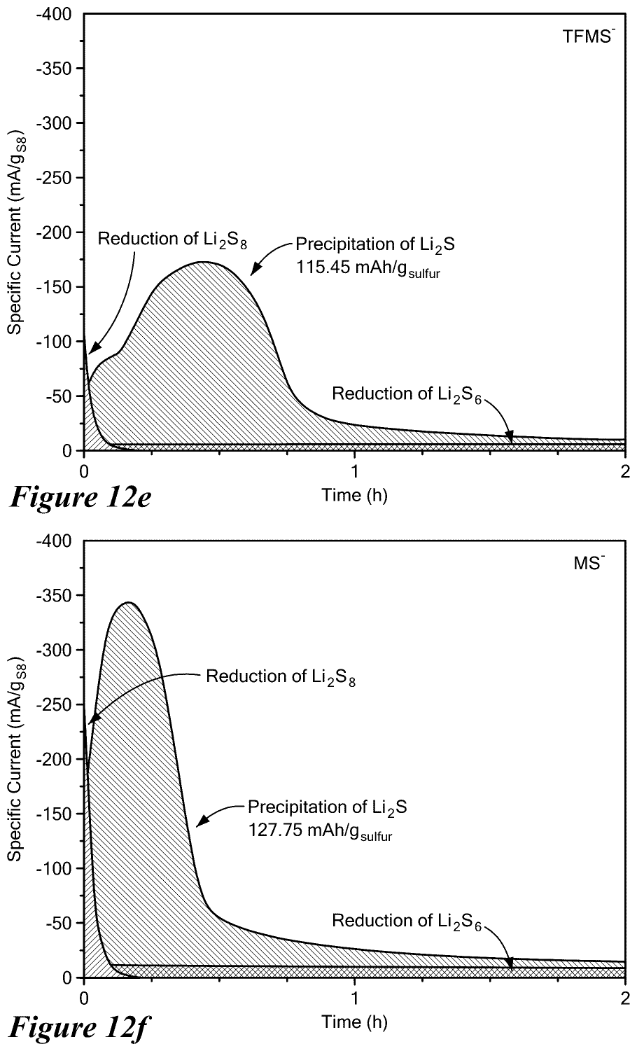

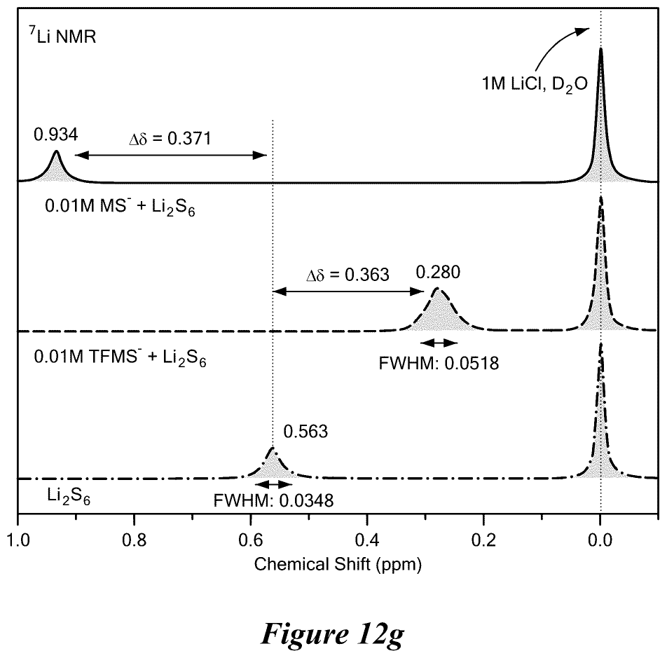

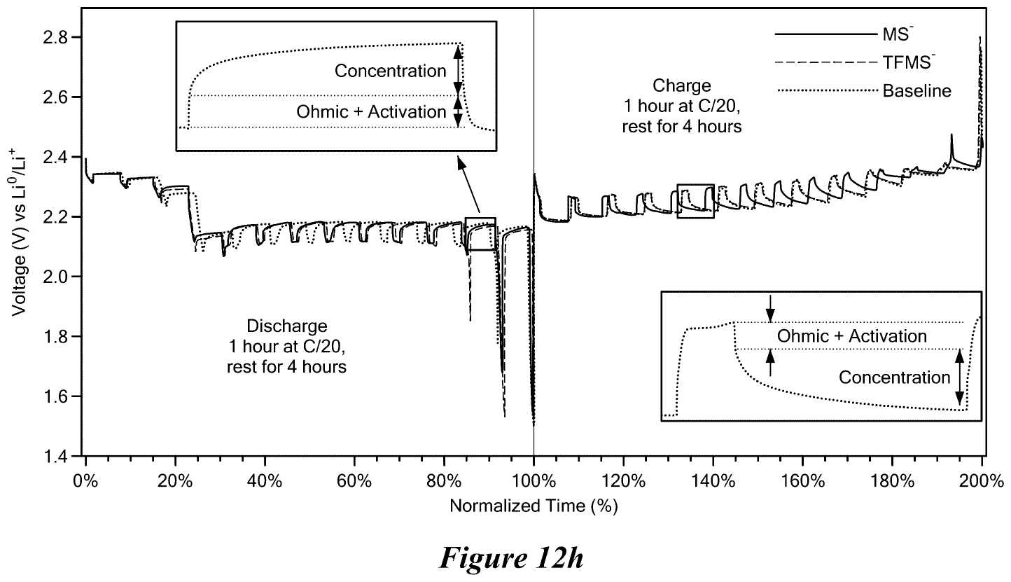

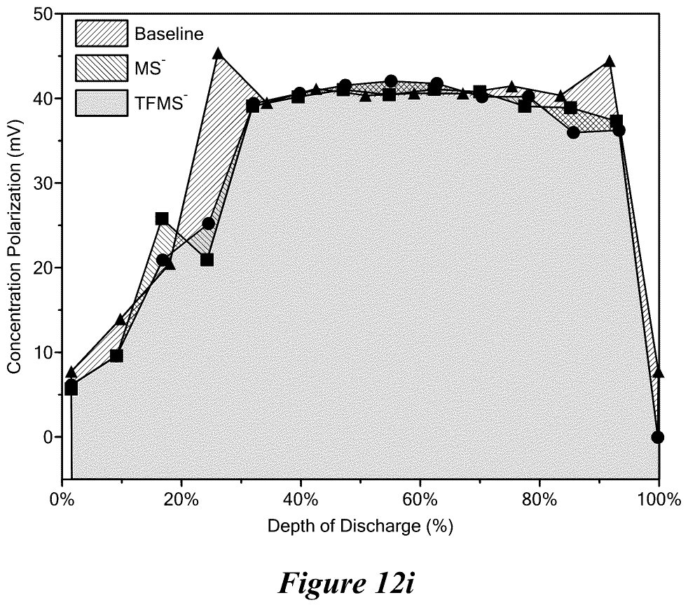

To investigate the impact of additives on LiPs, it was first verified that the electrochemical stability of the electrolyte with addition of the additives was not hampered. The linear sweep voltammetry reveals no new current peaks within the voltage range relevant to cycling or cyclic voltammetry. Once this was tested, symmetric cells with 0.25M Li₂S₆ and 1M LiTFSI catholytes on carbon paper were prepared with and without the TBA additives (FIGS. 12a-c). These were overlayed with the cyclic voltammogram (CV) of the corresponding electrolyte solutions (1M LiTFSI, with and without additives) without Li₂S₆ to validate those species were not electrochemically active. The cyclic voltammograms (CVs) show six distinct peaks; previous reports identified four, and suggested a mechanism where the Li₂S₆ was directly reduced to/oxidized from Li₂S/Li₂S₂, and the Li₂S₆ was oxidized to/reduced from S₈, Ref. 2 [34, 35]:

$${S}_{6}^{2 -} + 10 {e}^{-} + 12 {Li}^{+} ↔ 6 {Li}_{2} S$$

$$4 {S}_{6}^{2 -} ↔ 8 {e}^{-} + 3 {S}_{8}$$

Given that the two additional peaks are seen in the baseline, it suggests they are present in the system and not because of the additives. As Li₂S₆ is initially the only electrochemically active species present, we propose that it is first reduced to a shorter-length polysulfide such as Li₂S₄, corresponding to cathodic peak b₁ and then reduced to Li₂S at peak c₁. The anodic peaks for the oxidation of Li₂S to Li₂S₄, and Li₂S₄ to Li₂S₆ are c₂ and b₂, respectively. Lastly, the same step for Li₂S₆ oxidation to S₈ as proposed previously is observed at a₂, with the corresponding reduction of S₈ to Li₂S₆ being observed at a₁ Ref. 2 [34, 35]. The observation of peaks b₁ and b₂ may have been possible due to the usage of carbon paper electrodes instead of stainless steel or aluminum, whereby the greater surface area allows for improved measurement sensitivity. From these observations, the following reactions are proposed:

$$\begin{matrix}{S}_{4}^{2 -} + 6 {e}^{-} + 8 {Li}^{+} ↔ 4 {Li}_{2} S & ( peaks {c}_{1} , {c}_{2} ) \\ 2 {S}_{6}^{2 -} + 2 {e}^{-} ↔ 3 {S}_{4}^{2 -} & ( peaks {b}_{1} , {b}_{2} ) \\ 8 {e}^{-} + 3 {S}_{8} ↔ 4 {S}_{6}^{2 -} & ( peaks {a}_{1} , {a}_{2} )\end{matrix}$$

Notably, comparison between the baseline and additives reveals that there is a smaller potential difference between peaks a₁ and a₂ (0.545V for baseline, 0.501V for TFMS, 0.496V for MS), as well as c₁ and c₂ (0.539V for baseline, 0.499V for TFMS, 0.502V for MS) when the additives are present. This decreased potential separation points to a smaller activation barrier when the additives are present, especially for the reversible conversions between Li₂S₆ and S8, as well as Li₂S4 and Li₂S. Nonetheless, further experiments are needed to elucidate the nature of this reduced activation energy.

To probe the additives' impact on nucleation and growth of Li₂S, potentiostatic discharge experiments were carried out. This is the rate-limiting step of the discharge, involving a liquid-solid phase transition as the Li₂S nucleates and grows, which makes understanding the additives' impact on this step crucial Ref. 2 [8]. A higher response current is observed with the addition of the additives (FIGS. 12d-f). According to Faraday's law, the increased current response points to more nucleation taking place. Even with the diluted concentration arising from the additives only being present in the electrolytes and not the catholyte, a notable improvement is observed (77.65 mAh/gS for baseline, 115.45 mAh/gS with addition of TFMS−, 127.75 mAh/gS with the addition of MS−). The trend is well aligned with the reduced activation barrier and availability for interaction with redox reactions due to the solvation structure predicted by MD simulations, and points to these factors improving the kinetics of Li₂S nucleation.

Ex-situ experiments were next conducted to directly probe interactions between the additives and Li₂S₆. After rigorous manual mixing, ⁷Li NMR measurements of the sample were made (FIG. 12g). A shift towards more negative values (upfield shift) is observed with the addition of TFMS−, whereas a downfield shift is seen when MS− is added. Previous studies have used ⁷Li MAS NMR to measure polysulfides and found a downfield shift as polysulfide length decreased Ref. 2 [36]. This may suggest that the interaction with MS− leads to short-chain polysulfides, and that with TFMS− results in long-chain polysulfides. Although it was not possible to form a solution of Li₂S in a relevant solvent to confirm, the trend observed supports findings of the nucleation study whereby MS− facilitates the conversion of intermediate-length to short-length polysulfides. Contrarily, the upfield shift for TFMS− prompted further investigation due to the evidence of increased Li₂S nucleation. This suggested that there may be an interaction with the solvent that is hindering the ex-situ observation TFMS−'s interaction with polysulfides. The wider peak, evidenced by increased Full Width at Half-Maximum (FWHM, 0.0518 for TMFS−, 0.03484 for baseline), can be a result of changes in the solvation environment of Li or increased solution viscosity. Previous investigation of polymerized-DOL (p-DOL) observed an upfield shift relative to DOL due to the greater shielding of the long-chain of the polymer Ref. 2 [37]. The high salt concentration in the electrolyte and presence of NO₃⁻ anion may be delaying the polymerization Ref. 2 [38], however the findings are consistent with an additive-solvent interaction and will be further investigated.

GITT was next employed to further investigate the additives' impact on cathodic kinetics. Initial inspection of the charge discharge profile suggested similar polarization profiles with and without additives (FIG. 12h), so the total polarization at each depth of discharge was broken down into the constituent ohmic, activation and concentration polarization. Namely, ohmic and activation polarization are a result of resistance from the system (electrolyte, electrodes) and charge transfer kinetics from the redox reactions, respectively. Meanwhile, concentration polarization is observed in the gradual and slower voltage relaxation that occurs after, reflecting the mass transfer of active species from electrolyte to the electrodes.

A lower concentration polarization is observed at a DoD of approximately 25% when the additives are present (21.1 mV for MS−, 25.2 mV for TFMS−, 45.2 mV for baseline) (FIG. 12i). This is the beginning of the second discharge plateau, where conversion to intermediate-length polysulfides and Li₂S nucleation begins. The lower polarization suggests that the additives may be assisting with the mass transfer of polysulfides from the bulk electrolyte to the solid cathode, hence why faster Li₂S nucleation kinetics were also observed. This observation is further supported by the lower concentration polarization observed for the additives at a DoD of approximately 90% (37.4 mV for MS−, 36.3 mV for TFMS−, 44.4 mV for baseline). This is within the third discharge plateau, where intermediate-length polysulfides formed during the second discharge plateau are being reduced to Li₂S. These findings support the results from MD simulations where the additives are present in the solvation shell of the Li⁺, being more readily available for redox reactions in the cells as evidenced by the improved kinetic performance.

### Example 10: Electrochemical Performance

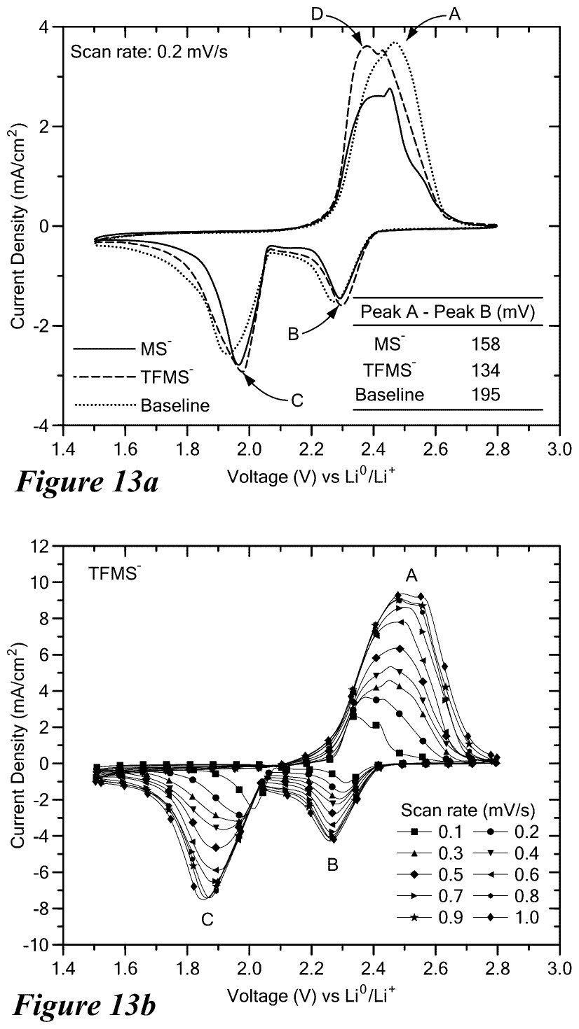

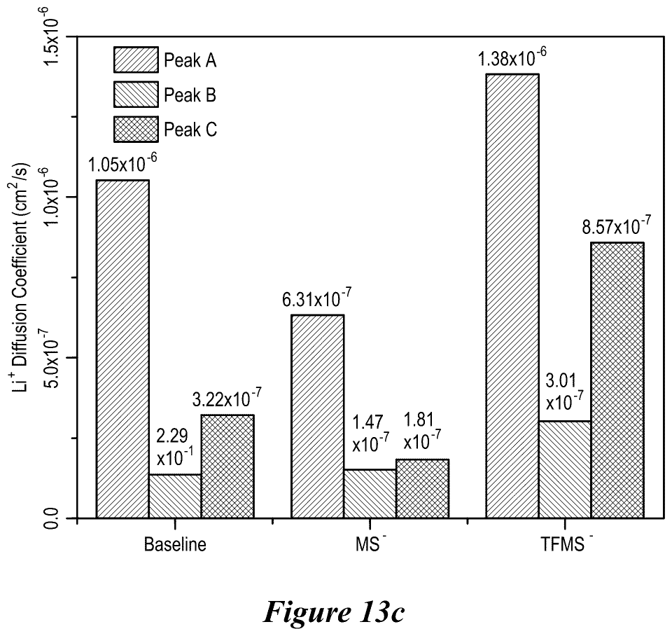

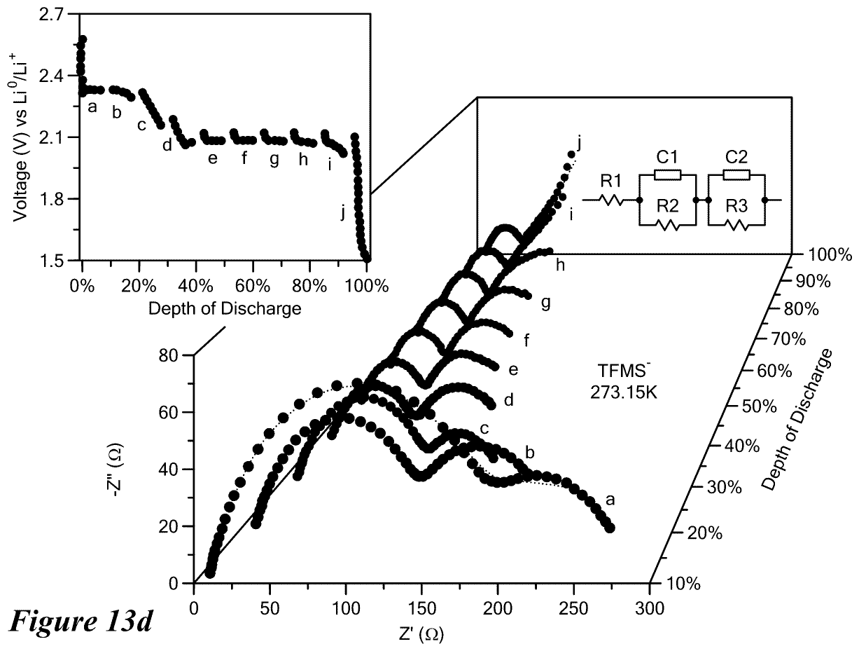

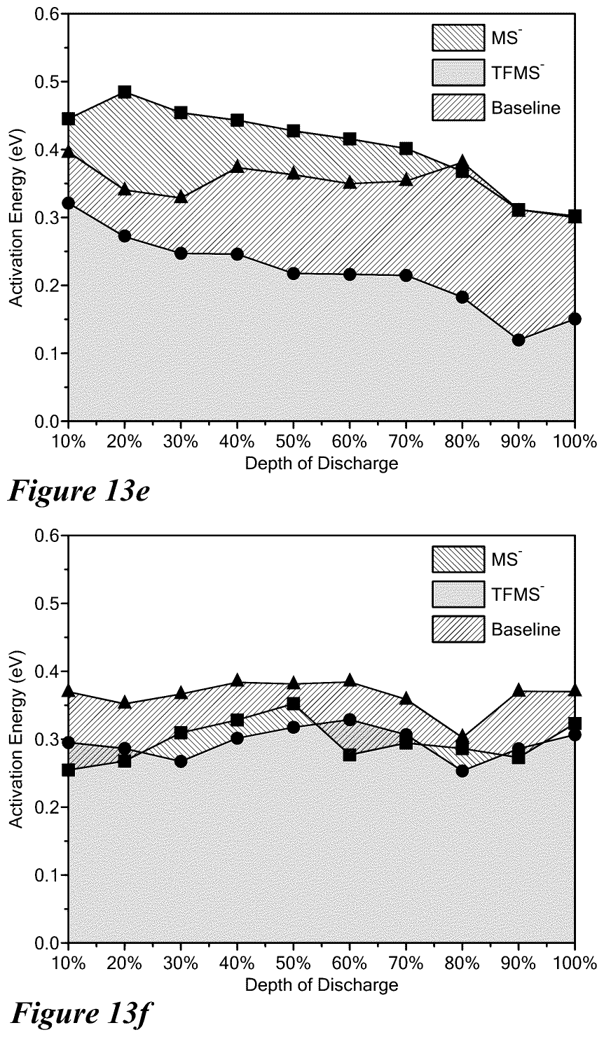

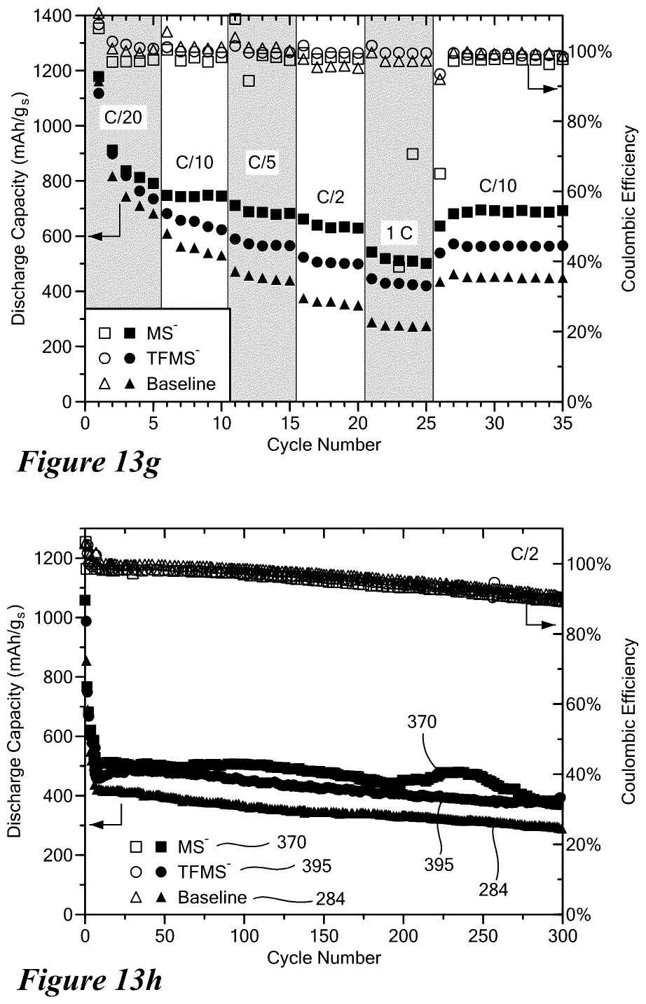

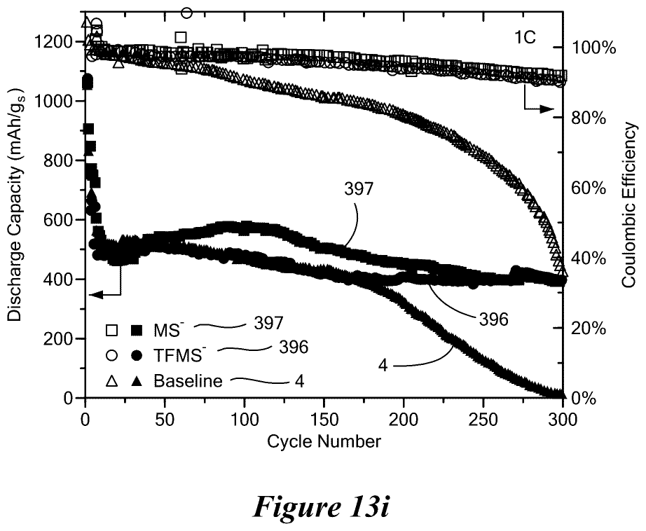

Cyclic voltammetry (CV) analysis was performed to better elucidate the impact of the additives on the SRR and the kinetics of polysulfide formation within a Li—S coin cell configuration. FIG. 3a displays the four major redox peaks observed in the Li—S system. Peak A (˜2.46 V) corresponds to the oxidation of Li2Sx (4≤x≤8) to S₈, while peak B (˜2.4 V) represents the reverse reduction of S8 to long chain and soluble polysulfides. Peak C (˜1.95 V) is attributed to the further reduction of soluble polysulfides to Li2S or Li2S2, and peak D (˜2.38 V) reflects the reverse oxidation of these species Ref. 2 [39]. Additionally, FIG. 3a illustrates the impact of the additives on the potential at which the SRR occurred with both TFMS and MS showing a higher reduction potential (Peak B and C) and a lower oxidation potential (Peak A and D) than the baseline. This shift suggests that the additives behave similarly to electron withdrawing groups, pulling electron density away from the polysulfides, analogous to the deshielding effect observed in FIG. 11h. By making the polysulfides more electron deficient, TFMS and MS facilitate their ability to accept electrons; thus, raising the reduction potential, while reducing their ability to donate electrons, resulting in lower oxidation potential as seen in FIG. 13a. This behavior was also observed in a previous study, where solvents with higher acceptor numbers (AN) or stronger electron-withdrawing character exhibited higher SRR potentials Ref. 2 [25]. Moreover, adding TFMS and MS led to a smaller peak separation (ΔEp=EpA−EpB) compared to the baseline (134, 158, and 195 mV, respectively), indicating more efficient electron transfer between the electrode and the analyte Ref. 2 [40].

FIG. 13b displays the CVs of the TFMS-containing electrolyte at scan rates ranging from 0.1 to 1 mV/s. CV measurements were employed to estimate the Li⁺ diffusion coefficient (D_{Li+}), investigate polysulfide formation kinetics, and assess the rate-limiting step of the redox process Ref. 2 [41]. The D_{Li+} was calculated using the Randles-Ševčík equation, averaged across peaks A, B, and C. As shown in FIG. 13c, a linear relationship between peak current and the square root of scan rate confirms diffusion-controlled behavior, allowing the extraction of DLi⁺ values. The calculated D_{Li+} are presented in FIG. 13c, where TFMS exhibits a higher average D_{Li+} (8.46×10⁻⁷ cm²/s) compared to the baseline (5.35×10⁻⁷ cm²/s) and MS (3.20×10⁻⁷ cm²/s). This enhanced Li⁺ diffusivity with TFMS suggests improved ionic transport within the cell, contributing to better SSR kinetics Ref. 2 [41, 42].

In contrast, the lower D_{Li+} observed for MS is linked to its strong deshielding effect on Li⁺ ions associated with polysulfides. As shown in FIG. 12g, the presence of MS induces a deshielding effect on Li⁺ in Li₂S₆, suggesting that MS⁻ interacts strongly with Li⁺ and reduces the influence of the polysulfide anion. This promotes the formation of an anion-rich solvation sheath, which displaces polar solvent molecules from the primary coordination shell of Li⁺ Ref. 2 [43]. Such a solvation environment hinders Li⁺ mobility and limits polysulfide transport, both of which are critical to mitigating the polysulfide shuttle effect. While similar anion-mediated solvation structures have been shown to enhance interfacial stability and suppress Li plating in other systems Ref. 2 [43], in this case, the stronger Li⁺-MS− association increases the energy barrier for ion transport and slows down redox kinetics.

Furthermore, the impact of the additives on the activation energy of Li—S cells across the depth of discharge (DoD) and state of charge (SoC) was investigated, as described in previous studies Ref. 2 [41, 44]. FIG. 13d illustrates the EIS spectra of the TFMS-containing electrolyte measured throughout the DoD, with the inset showing the corresponding discharge profile at 273.15 K. Each interruption in the discharge profile corresponds to a time point where EIS was performed. During discharge, soluble polysulfides species migrate and are reduced at the Li metal surface, incorporating Li₂S/Li₂S₂ into the anode SEI Ref. 2 [45]. These same polysulfides can also re-oxidize or further reduce at the sulfur cathode, contributing to the formation of a Li₂S-rich CEI Ref. 2 [46]. As a result, interphase layers on both electrodes evolve in tandem with DoD and SoC, leading to the impedance variations observed. For this reason, the activation energy (Eₐ) was determined based on the combined inverse resistance of the charge-transfer and SEI (Rct+RSEI)⁻¹.

FIG. 13e shows the variation of Eₐ across the DoD. On average, TFMS exhibits a lower Eₐ than MS and the baseline, indicating lower energetic barriers for polysulfide formation and faster interfacial kinetics, consistent with the CV results (FIG. 12a-c). MS, in contrast, displays a higher Eₐ early in discharge, which gradually decreases and converges with the baseline at ≈80% DoD. Although MS− reduces the bulk DLi⁺ by tightly coordinating Li⁺ (FIG. 13c), the same Li⁺-MS⁻ interaction triggers an anion-derived, Li₂S-rich SEI that dramatically lowers charge-transfer resistance after ≈80% DoD; once this highly conductive interphase is established, the combined (Rct+RSEI) term falls and the apparent activation energy drops below the baseline Ref. 2 [43, 45, 46]. Resulting in MS− displaying a lower Ea energy across the SoC as seen in FIG. 13f. These trends indicate that the late-stage reduction in Eₐ for the MS electrolyte is governed more by interfacial kinetics than by bulk diffusion limitations and it will be discussed in depth in the upcoming sections.

To assess the rate capability of the electrolyte additives, cells were prepared and cycled incrementally from C/20 to 1C, and then back to C/10 (FIG. 13g). A greater discharge capacity is observed with the additives, and the cell with 0.01M MS− exhibits the highest discharge capacity at every cycle, followed closely by that with 0.01M TFMS−. The improved overall performance of the additives reflects the lower barrier to conversion of intermediate-length polysulfides to short-chain ones, as well as long-chain polysulfides to S8, made possible by their presence in the solvation shell of Li⁺. Assessing the cycling data at 1C illustrates why a superior performance is observed with MS− over TFMS−. Namely, the baseline has a discharge capacity of 281.11 mAh/gS, while TFMS− has a discharge capacity of 443.84 mAh/gS and MS− a discharge capacity of 540.6 mAh/gS, corresponding to 58% and 92% improvements, respectively (cycle 21). To support higher rate cycling, rapid LiPs conversion kinetics are needed. Therefore, the improved performance at the high rate cycling for MS− points to improved kinetics, supported by previous results. Namely, given the faster kinetics at the rate limiting step of Li₂S nucleation Ref. 2 [8], made by possible by a spontaneous ex-situ interaction and lower polarization at the relevant DoDs, MS− leads to improved cycling performance.

The increased capacity is also observed in long-term cycling at C/2 (FIG. 13h). After 300 cycles, the cell with TFMS− had a specific capacity of 394.83 mAh/gS, compared to 369.76 mAh/gS with MS− and 284.12 mAh/gS for the baseline, representing an improvement of 39% and 30%, respectively. Interestingly, MS− exhibits higher discharge capacity than TFMS− until cycle 286, reflecting the faster polysulfide kinetics. However, the capacity fading per cycle gives further insight to the role of TFMS−; relative to the seventh cycle where stabilization has occurred, TFMS− has a capacity decay rate per cycle of 0.07%, followed by 0.10% for MS− and 0.12% for the baseline. For long-term cycling, anodic stability is crucial to ensure active material utilization and a delicate tradeoff between cathodic kinetics must be achieved Ref. 2 [47]. Therefore, the role of TFMS− may be more centered around anodic protection which provides increased capacity at long-term cycling. Cells that were cycled at 1C further support this observation (FIG. 13c). After 300 cycles, the baseline cell failed, whereas MS− had a discharge capacity of 397.48 mAh/gS (0.12% capacity fading per cycle after stabilization) and TFMS 395.74 mAh/gS (0.08% capacity fading per cycle after stabilization). The faster rate requires rapid kinetics, hence why there is a smaller gap between capacity, although the lower fading points to the protective role of TFMS− for the anode. This underscores the tunability of TBA additives by effective selection of the anion.

### Example 11: Operando Raman and Distribution of Relaxation Time

Operando Raman spectroscopy was employed to monitor the real-time changes in polysulfide speciation during discharge and charge process. This technique enables direct observation of the dynamic interactions between the additives and polysulfides, offering mechanistic insight into how the additives influence the SRR, modulate intermediate species, and affect the formation pathways of Li₂S, Ref. 2 [25, 44]. Simultaneously, distribution of relaxation times (DRT) analysis was conducted since it deconvolutes the impedance spectra into distinct time constants corresponding to charge transfer, diffusion, and interfacial processes, revealing additive-induced changes in polysulfide conversion and SEI/CEI behavior typical of Li—S and Li⁺ systems Ref. 2 [4, 48]. While operando Raman captures real-time chemical transformations, DRT provides a complementary kinetic perspective Ref. 2 [44, 48]. Together, these techniques offer a synchronized and comprehensive view of how additive chemistry influences sulfur redox reactions and overall cell performance.

Operando Raman spectroscopy was performed using an EL-Cell configuration with a 638 nm laser, as described in our previous work Ref. 2 [25, 44]. Meanwhile, DRT analysis was conducted on a Li—S coin cell, with impedance data validated via Kramers-Kronig analysis and processed using DRT tools, an open-source MATLAB toolbox Ref. 2 [4, 49].

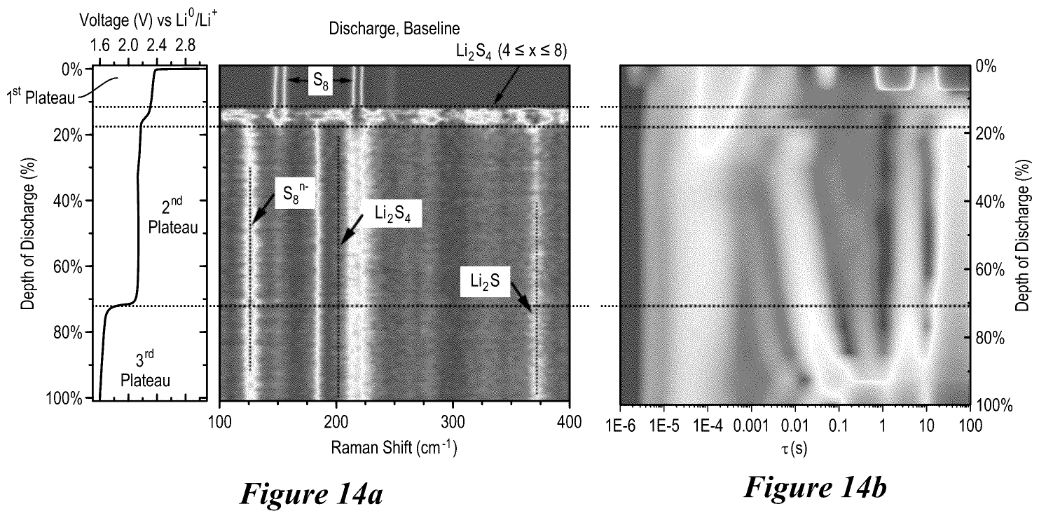

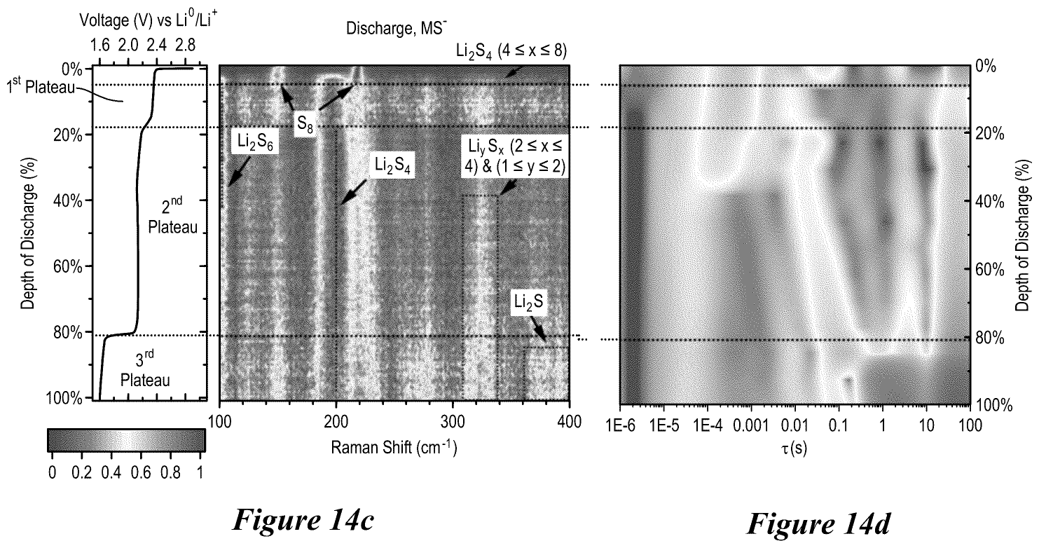

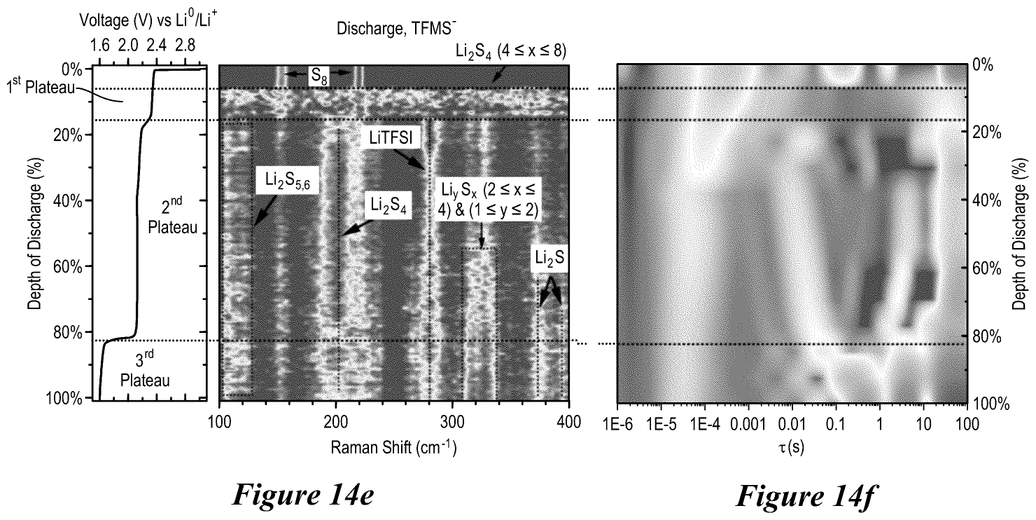

FIG. 14 illustrates the operando Raman (a, c and e) and the DRT (b, d and f) contour plots for the baseline (a and b), 0.01M TFMS (c and d) and 0.01 M of MS (e and f) across the DoD. The evolution of DRT peaks parallels the Raman contour and voltage profile, indicating that impedance responses shift coherently with polysulfide transformations as S₈ dissolves (peaks (152 cm⁻¹, 220 cm⁻¹), Li₂S₄ (202 cm⁻¹) emerges, and Li₂S precipitates (˜370 cm⁻¹). By isolating charge-transfer, diffusion, and interfacial contributions associated with these phase transitions, DRT complements operando Raman by correlating molecular speciation with electrochemical kinetics, yielding an integrated understanding of sulfur redox processes that is inaccessible through either technique alone.

DRT also takes into account all of the polarization responses of the system. While Nyquist EIS doesn't sperate the responses as well.

In DRT, each peak represents an electrochemical process and the integration of the area can be utilized to determine the polarization resistance for each electrochemical step. As seen on the activation energy plot, the highest resistance across the depth of discharge is associated to the first conversion of S8 to long chain polysulfides. This is not only validated by the DRT data but also the activation energy values and the diffusion coefficient value in which peak B has the lowest D_Li value rendering it as the slowest or the rate limiting step. The other rate limiting step is the solid-liquid transition between Li2S/Li2S2 to Short chain or soluble polysulfides as seen on the DRT value as function of charge. Although the transition can't be directly observed through operando measurements

The corresponding S₈ peaks (152 cm⁻¹, 220 cm⁻¹), as well as some of the corresponding shoulder peaks (245, 436) are observed in all the cells Ref. 2 [50]. Importantly, the S₈ peaks disappear faster in the experiments with the additives, corresponding to the reduction of sulfur. For the baseline, S₈ reduction occurs at 13% Depth of Discharge (DoD), while it occurs at 5.5% for TFMS⁻ and 3.4% MS⁻. This points to the additives assisting in the reduction of S₈, supporting the improved cell performance observed (FIG. 13g-i) and decreased activation energy suggested by the symmetric Li₂S₆ cells investigated in FIGS. 12a-c. Immediately after S₈ reduction, a strong peak corresponding to Li₂S₄ at 202 cm⁻¹ is observed for all cells Ref. 2 [51]. The lingering Li₂S₄ peak has been reported before, and in the case of the baseline minimal conversion to shorter-length polysulfides is observed (Li₂Sₙ, 1≤n≤3), as evidenced by the weak intensity peak at 370 cm⁻¹ corresponding to Li₂S Ref. 2 [52-54] Immediately after S₈ reduction, a strong peak corresponding to Li₂S₄ at 202 cm⁻¹ is observed for all cells Ref. 2 [51]. The lingering Li₂S₄ peak has been reported before, and in the case of the baseline minimal conversion to shorter-length polysulfides is observed (Li₂Sₙ, 1≤n≤3), as evidenced by the weak intensity peak at 370 cm⁻¹ corresponding to Li₂S Ref. 2 [52-54], and presence of long-chain polysulfides (S₈ⁿ⁻ at 125 cm⁻¹) throughout discharge Ref. 2 [55]. The lingering Li₂S₄ peak has been reported before, and in the case of the baseline minimal conversion to shorter-length polysulfides is observed (Li₂Sₙ, 1≤n≤3), as evidenced by the weak intensity peak at 370 cm⁻¹ corresponding to Li₂S [52-54], and presence of long-chain polysulfides (S₈ⁿ⁻ at 125 cm⁻¹) throughout discharge [55].

Contrarily, long chain polysulfides are not observed in experiments with the additives, that may be due to laser scattering or could point towards faster reduction to intermediate and short range polysulfides. For MS⁻, a high peak at 106 cm⁻¹ corresponding to Li₂S₆ appears immediately after S₈ reduction, and this peaks as well as that for Li₂S₈ appear for TFMS⁻ at the start of the second discharge plateau Ref. 2 [56]. These may point to the additives assisting in the reduction of long-chain polysulfides to shorter ones, and the appearance of short-chain polysulfides in the region of 320-400 cm⁻¹, namely of S₃²⁻ at 325 cm⁻¹ and Li₂S, further support this observation Ref. 2 [57, 58]. The detection of S₃²⁻ for the cells containing additives may play a role in explaining the improved cycling performance observed. It has previously been proposed that reduced sulfur species (Li₂Sₙ, 1≤n≤2) equilibrate with remaining species (S₈, Li₂S₈) to form stable intermediates such as Li₂S_{3, 4}, driving consumption of S₈ and preventing early precipitation of Li₂S Ref. 2 [7, 58]. Although this was suggested as being more prominent in high donor number solvents, the additives may facilitate this. This is especially prominent with MS⁻, where corresponding Li₂S peaks at 370 cm⁻¹ Ref. 2 [53, 54] and 392 cm⁻¹ Ref. 2 only appear at a DoD of 86%, as compared to the baseline where it is present immediately after S₈ reduction. The more effective reduction of S₃²⁻ to Li₂S may also shed light to the higher capacity observed during cycling of additive containing cells.

### Example 12: Polymerization of DOL

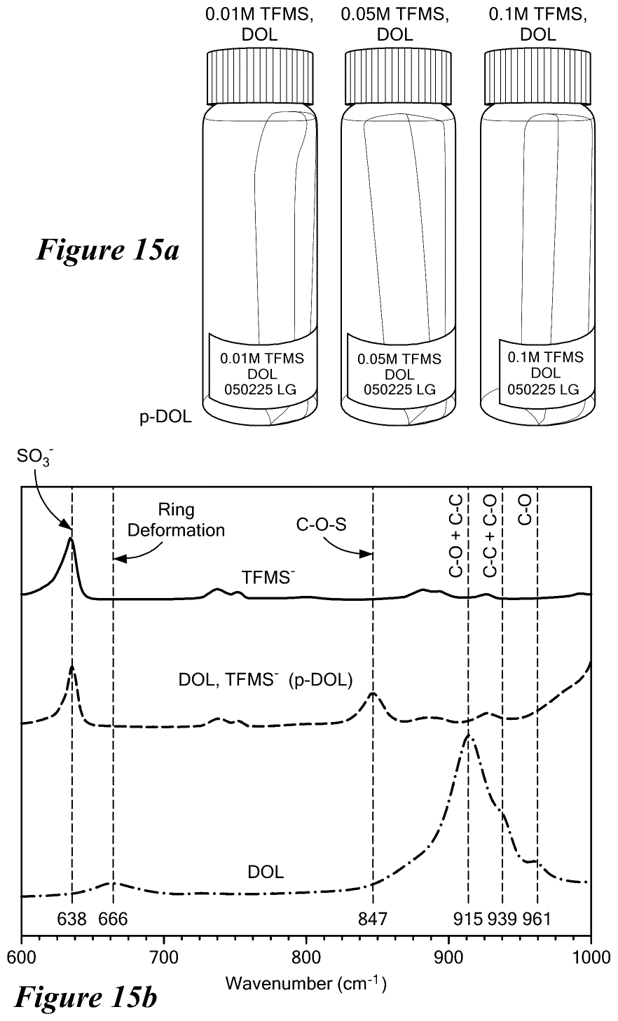

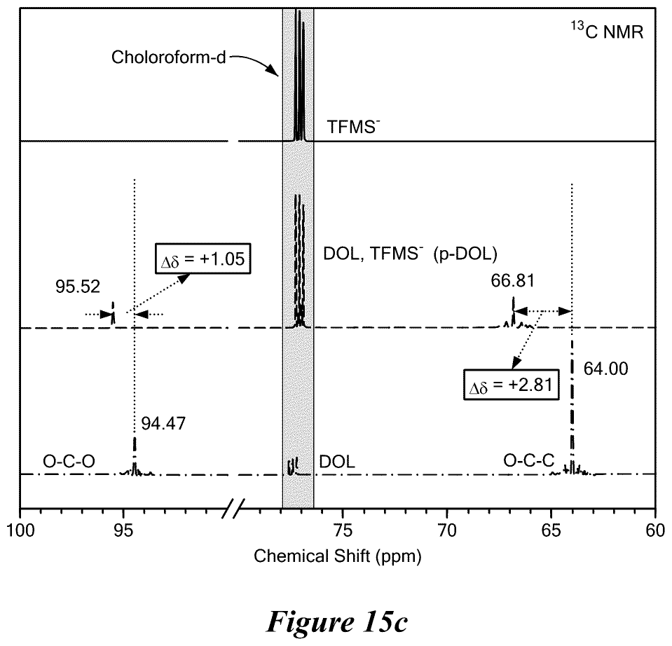

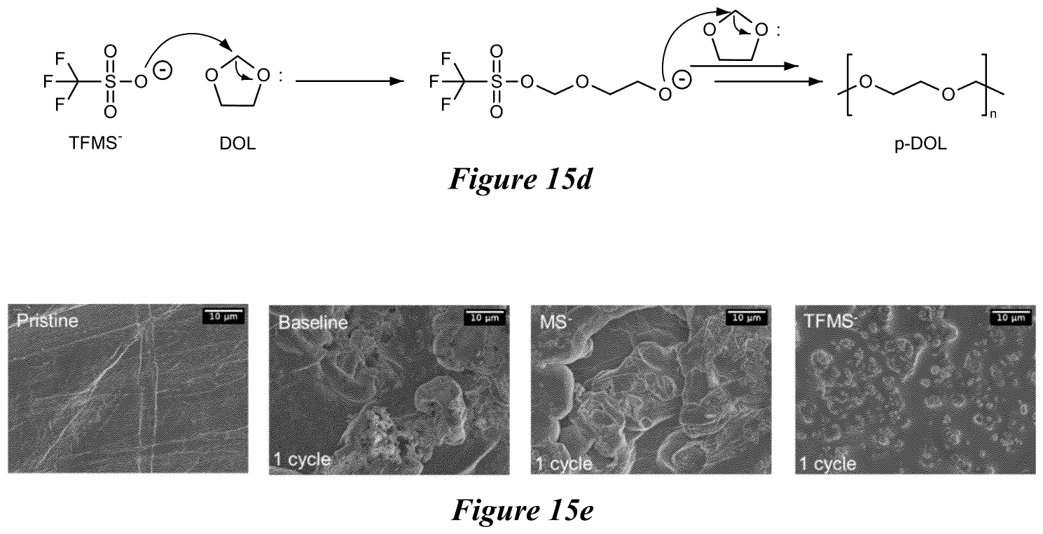

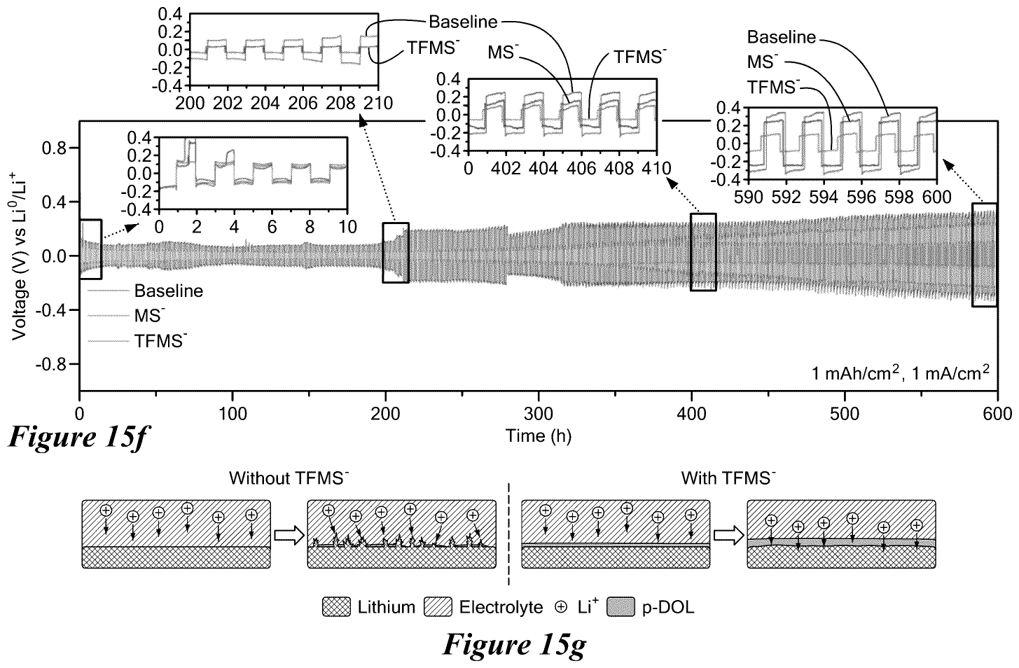

To probe the interaction of additives with the electrolyte solvents, 0.51M solutions of the additives with DOL, DME and a 1:1 v:v mixture of DOL:DME were prepared. Higher concentrations than employed in the electrolyte for the cells were possible as the lower overall salt concentration (absence of LiTFSI, LiNO₃) allowed for greater solubility of the additives. Notably, a white crystalline substance formed for DOL with TFMS⁻ (FIG. 15a), pointing to possible polymerization. As FIG. 15a also shows, lower concentrations of TFMS⁻ (0.01M) induce this white substance to form, suggesting that at concentrations used in the cells this phenomenon may be occurring.

FTIR measurements of the sample suggested that a ring opening polymerization was occurring—the peak corresponding to ring deformation at 666 cm⁻¹ Ref. 2 (FIG. 15b) is visible in the DOL but not in the substance. Similarly, peaks corresponding to stretching of C—C and C—O bonds have much lower intensity (915 cm⁻¹, 939 cm⁻¹, 961 cm⁻¹), indicating lower strain given that the ring structure is no longer present. The FTIR suggests that the gel phase contains the p-DOL and the liquid has unreacted TFMS⁻, so that it is mostly DME. The amorphous structure observed is consistent with previous characterization of salt-free p-DOL Ref. 2 [61].

Further investigation was conducted using ¹³C NMR. 5 wt. % mixtures of the 0.51M TBA⁺ additives and DOL in chloroform-d6 (Sigma Aldrich) were prepared. When TBA-TFMS is added, a noticeable downfield chemical shift is observed for the two chemical environments observed in carbon (FIG. 15c). This de-shielding of the carbon once more points to a polymer chain being formed, and is aligned with previous characterization of p-DOL Ref. 2 [61, 62]. Based on these results, an attack on DOL by the TFMS⁻ anion is proposed as the ring-opening polymerization mechanism (FIG. 15d) Ref. 2 [16]. TFMS⁻ is the conjugate base of trifluoromethanesulfonic acid, a super acid with a pKₐ approximated as −12 in water Ref. 2 [63], meanwhile methanesulfonic acid has a pKₐ of −1.9 Ref. 2 [64]. Therefore, TFMS⁻ and MS⁻ are both stable and effective leaving groups suggesting if the TBA⁺ were initiating the polymerization, it would be observed with both additives. Further, a novel FTIR peak appears at 847 cm⁻¹, which has previously been reported as the C—O—S bond of an ester sulfonate Ref. 2 [65]. This is expected with the proposed mechanism for attack by TFMS⁻, and the preservation of sulfonate group from the TFMS⁻ at 638 cm⁻¹ further reinforces this being the end group of the polymer (FIG. 15b) Ref. 2 [66]. Although previous in-situ DOL polymerization involving the TFMS⁻ anion has focused on salts such as Al(TFMS⁻) ₃ and Sc(TFMS⁻)₃ that leverage the Lewis acidity of the base Ref. 2 [16, 61] this leverages the Lewis basicity of the anion.

To assess whether DOL polymerization was occurring in-situ, coin cells were prepared and cycled once at C/20, using 1:1 v:v DOL:DME, 1M LiTFSI, 0.1M LiNO₃ and 0.01M of the additives. It has previously been reported that the NO₃⁻ anion interacts electrostatically with DOL, coordinating with it to limit polymerization while also plays a crucial role in ensuring Li metal electrode reversibility Ref. 2 [38]. SEM imaging of the anode (FIG. 15c) clearly reveals a homogenous layer of p-DOL on the surface of the cell with TFMS⁻, consistent with previous SEM imaging of p-DOL on lithium anodes Ref. 2 [67]. This evidence supports the fact that in-situ polymerization occurs, despite the presence of LiNO₃. It also reveals smaller and homogenously shaped lithium protrusions that may lead to a more stable SEI formation and lithium plating long-term. To verify this, symmetric Li|Li cells were prepared using the electrolyte with additives (FIG. 15f), where 1 mAh cm⁻² of Li was deposited and subsequently stripped. TFMS⁻ exhibits the lowest polarization at 600 hours, remaining at approximately 0.10 V whereas the corresponding value for the baseline is 0.33 V. This supports that compared to the baseline, TFMS⁻ assisted with the formation of an even SEI layer, where the p-DOL layer formed resulted in decreased polarization for Li stripping and plating.

The polymerization of DOL may have an important role in improving cell performance. In-situ polymerized electrolytes have advantages over ex-situ formed solid polymer electrolytes that suffer from higher interfacial resistance, and could be less reactive towards lithium metal than liquid electrolyte Ref. 2 [61]. The present system benefits from a layer of p-DOL that protects the anode, while maintaining ionic conductivity through the DME that remains liquid. LiNO₃, present in the electrolyte, has been previously shown to reduce the extent of catalytic DOL polymerization, allowing unreacted DOL and in this case the DME to serve as a plasticizer Ref. 2 [68, 69]. The result is very desirable mechanical properties, namely flexibility to support lithium deposition and dissolution Ref. 2 [68]. The formation of a protective layer of p-DOL may also reduce dendrite formation; uneven dendrite nucleation occurs during the first cycle when an SEI has not formed, and lithium preferentially plates on these dendrites over the pristine anode Ref. 2 [9]. By forming a polymer coating, active material can be preserved, enhancing long-term cycle life (FIG. 15g). The results suggest that the protective layer hampers the damaging polysulfide shuttling that consumes lithium and forms insoluble short-chain polysulfides. In turn, active material is preserved resulting in greater long-term capacity retention (FIGS. 13g-i) and lithium plating-stripping performance.

### Example 13: Mechanistic Evaluation

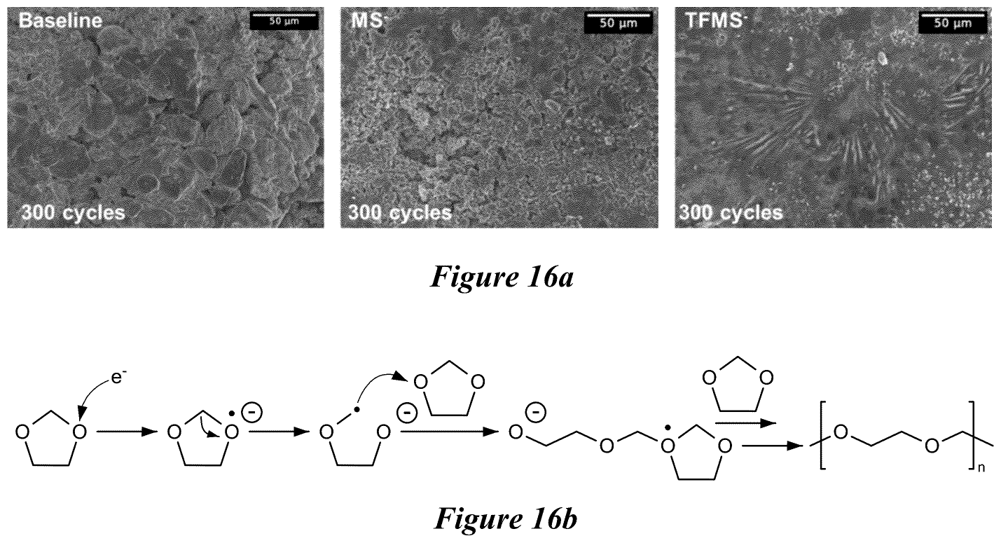

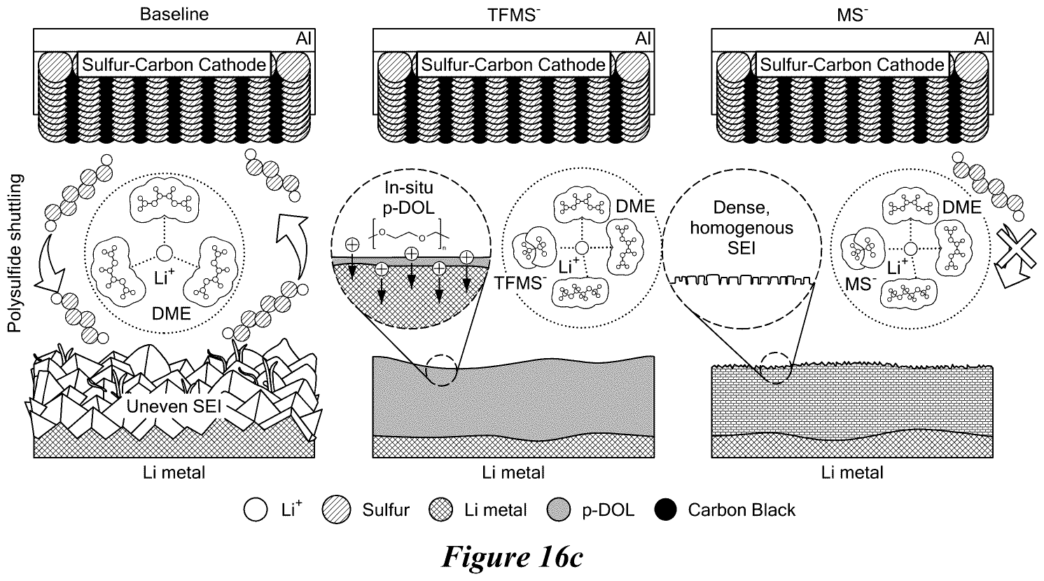

To understand whether the observations made are reflected on the anode after extensive cycling, SEM imaging were performed. The anode of cells with 300 cycles were utilized (FIG. 16a); p-DOL is clearly visible in the cell with TFMS⁻, where a smooth and homogenous SEI layer is visible Ref. 2 [67]. Similarly, with the addition of MS⁻ smaller, more frequent lithium structures are observed, as well as some indication of polymer on the structure. The polymer observed is likely a result of electrochemical polymerization of DOL, that has been reported previously where electron attack of the oxygen initiates the ring-opening polymerization (FIG. 16b) Ref. 2 [16]. This dense and homogenous SEI is critical to ensuring cyclability and energy density, and there have been efforts to maximize Li deposit density Ref. 2 [10]. The MS⁻ may be enabling the denser formation by de-shielding of Li⁺ as shown by ⁷Li NMR, leading to greater availability for redox reactions demonstrated by MD that facilitate uniform lithium deposition. This may also be contributing to improved Li₂S nucleation, demonstrated through both nucleation studies and seen by the earlier appearance in operando Raman.

From these observations, a mechanism of action for the additives is proposed (FIG. 16c). Central to both is the presence of additives in the outer solvation shell of Li⁺, making it available for redox reactions although not fully displacing DME. This availability is first witnessed with their in- and ex-situ interaction with polysulfides; a lower barrier to conversion between intermediate LiPs to Li₂S, as well as between intermediate LiPs to S₈. A spontaneous interaction between MS⁻ and the polysulfides causes this, while TFMS⁻ primarily interacts with DOL. _CV_ EIS_ Rate capability studies and long-term cycling reflect the faster LiPs conversion kinetics, lower overpotential and improved SEI formation, meanwhile Raman further supports these findings. The TFMS⁻ anion is confirmed to cause a ring-opening polymerization of DOL ex- and in-situ, giving further insights to the enhanced long-term performance.

As used herein, “consisting essentially of” allows the inclusion of materials or steps that do not materially affect the basic and novel characteristics of the claim. Any recitation herein of the term “comprising”, particularly in a listing of components of a composition or elements of a device, constitutes inclusion of alternative embodiments in which “comprising” is replaced with “consisting essentially of” or “consisting of”.

### Reference List 1 (Ref. 1)

Chen, H., Wu, Z., Zheng, M., Liu, T., Chen, Y., Jun Lü and Zhang, S. (2022). Catalytic materials for lithium-sulfur batteries: mechanisms, design strategies and future perspective. Materials Today, 52, pp. 364-388. doi.org/10.1016/j.mattod.2021.10.026.
Liu, Y.-H., Chang, W., Qu, J., Sui, Y.-Q., Abdelkrim, Y., Liu, H.-J., Zhai, X.-Z., Guo, Y.-G. and Yu, Z.-Z. (2022). A polymer organosulfur redox mediator for high-performance lithium-sulfur batteries. Energy Storage Materials, 46, pp. 313-321. doi.org/10. 1016/j.ensm.2022.01.021.
Liu, R., Wei, Z., Peng, L., Zhang, L., Zohar, A., Schoeppner, R., Wang, P., Wan, C., Zhu, D., Liu, H., Wang, Z., Tolbert, S. H., Dunn, B., Huang, Y., Philippe Sautet and Duan, X. (2024). Establishing reaction networks in the 16-electron sulfur reduction reaction. Nature, 626(7997), pp. 98-104. doi.org/10.1038/s41586-023-06918-4.
Manthiram, A., Fu, Y. and Su, Y.-S. (2012). Challenges and Prospects of Lithium-Sulfur Batteries. Accounts of Chemical Research, 46(5), pp. 1125-1134. doi.org/10.1021/ar300179v.
Nagde, K. R. and Dhoble, S. J., 2021. Li—S ion batteries: A substitute for Li-ion storage batteries. In Energy Materials (pp. 335-371). Elsevier.
Park, J.-W., Ueno, K., Tachikawa, N., Dokko, K. and Watanabe, M. (2013). Ionic Liquid Electrolytes for Lithium-Sulfur Batteries. The Journal of Physical Chemistry C, 117(40), pp. 20531-20541. doi.org/10.1021/jp408037e.
Shen, Z., Jin, X., Tian, J., Li, M., Yuan, Y., Zhang, S., Fang, S., Fan, X., Xu, W., Lu, H., Lu, J. and Zhang, H. (2022). Cation-doped ZnS catalysts for polysulfide conversion in lithium-sulfur batteries. Nature Catalysis, 5(6), pp. 555-563. doi.org/10.1038/s41929-022-00804-4.
Wu, H.-L., Shin, M., Liu, Y.-M., See, K. A. and Gewirth, A. A. (2017). Thiol-based electrolyte additives for high-performance lithium-sulfur batteries. Nano Energy, 32, pp. 50-58. doi.org/10.1016/j.nanoen.2016.12.015.
Wu, T., Ye, J., Li, T., Liu, Y., Jia, L., Sun, L., Liu, J. and Xie, H. (2022). Tetrathiafulvalene as a multifunctional electrolyte additive for simultaneous interface amelioration, electron conduction, and polysulfide redox regulation in lithium-sulfur batteries. Journal of power sources, 536, pp 231482-231482. doi.org/10.1016/j.jpowsour.2022.231482.
Yang, T., Qian, T., Liu, J., Xu, N., Li, Y., Grundish, N., Yan, C. and Goodenough, J. B. (2019). A New Type of Electrolyte System To Suppress Polysulfide Dissolution for Lithium-Sulfur Battery. ACS nano, 13(8), pp. 9067-9073. doi.org/10.1021/acsnano.9b03304.
Liu, Y.-H., Chang, W., Qu, J., Sui, Y.-Q., Abdelkrim, Y., Liu, H.-J., Zhai, X.-Z., Guo, Y.-G. and Yu, Z.-Z. (2022). A polymer organosulfur redox mediator for high-performance lithium-sulfur batteries. Energy Storage Materials, 46, pp. 313-321. doi.org/10. 1016/j.ensm.2022.01.021.
Zhong, Y., Wang, Q., Bak, S.-M., Hwang, S., Du, Y. and Wang, H. (2023). Identification and Catalysis of the Potential-Limiting Step in Lithium-Sulfur Batteries. Journal of the American Chemical Society, 145(13), pp. 7390-7396. 6doi.org/10.1021/jacs.2c13776.

### Reference List 2 (Ref. 2)

[1] S. Badhrinathan, H. Dai, and G. P. Pandey, “Challenges and Approaches to Designing High-Energy Density Lithium-Sulfur Pouch Cells,” Batteries & Supercaps, vol. 8, no. 4, p. e202400544, 2025.
[2] M. Zhao, B.-Q. Li, X.-Q. Zhang, J.-Q. Huang, and Q. Zhang, “A perspective toward practical lithium-sulfur batteries,” ACS Central Science, vol. 6, no. 7, pp. 1095-1104, 2020.
[3] X. Huang et al., “Comprehensive evaluation of safety performance and failure mechanism analysis for lithium sulfur pouch cells,” Energy Storage Materials, vol. 30, pp. 87-97, 2020.
[4] R. Soni, J. B. Robinson, P. R. Shearing, D. J. Brett, A. J. Rettie, and T. S. Miller, “Lithium-sulfur battery diagnostics through distribution of relaxation times analysis,” Energy Storage Materials, vol. 51, pp. 97-107, 2022.
[5] Q. Li et al., “Mo02@ C modified separator as an interlayer for high performance lithium-sulfur batteries,” Nanotechnology, vol. 32, no. 10, p. 105206, 2020.
[6] S. Parab et al., “Quantitative insights for diagnosing performance bottlenecks in lithium-sulfur batteries,” Energy & Environmental Science, vol. 18, no. 12, pp. 6283-6296, 2025.
[7] M. Cuisinier, C. Hart, M. Balasubramanian, A. Garsuch, and L. F. Nazar, “Radical or Not Radical: Revisiting Lithium-Sulfur Electrochemistry in Nonaqueous Electrolytes,” Advanced Energy Materials, vol. 5, no. 16, 2015.
[8] X. Sun et al., “Isolated Fe—Co heteronuclear diatomic sites as efficient bifunctional catalysts for high-performance lithium-sulfur batteries,” Nature communications, vol. 14, no. 1, p. 291, 2023.
[9] K. N. Wood et al., “Dendrites and pits: untangling the complex behavior of lithium metal anodes through operando video microscopy,” ACS central science, vol. 2, no. 11, pp. 790-801, 2016.
[10] Q. Dong et al., “A self-adapting artificial SEI layer enables superdense lithium deposition for high performance lithium anode,” Energy Storage Materials, vol. 45, pp. 1220-1228, 2022.
[11] J. Schuster et al., “Spherical ordered mesoporous carbon nanoparticles with high porosity for lithium-sulfur batteries,” Angewandte Chemie International Edition, vol. 15, no. 51, pp. 3591-3595, 2012.
[12] D. Su, D. Zhou, C. Wang, and G. Wang, “Toward high performance lithium-sulfur batteries based on Li₂S cathodes and beyond: status, challenges, and perspectives,” Advanced Functional Materials, vol. 28, no. 38, p. 1800154, 2018.
[13] N. Jayaprakash, J. Shen, S. S. Moganty, A. Corona, and L. A. Archer, “Porous hollow carbon@ sulfur composites for high-power lithium-sulfur batteries,” Angewandte Chemie-International Edition, vol. 50, no. 26, p. 5904, 2011.
[14] H. Wang et al., “Graphene-wrapped sulfur particles as a rechargeable lithium-sulfur battery cathode material with high capacity and cycling stability,” Nano letters, vol. 11, no. 7, pp. 2644-2647, 2011.
[15] Y. Chen, T. Wang, H. Tian, D. Su, Q. Zhang, and G. Wang, “Advances in lithium-sulfur batteries: from academic research to commercial viability,” Advanced Materials, vol. 33, no. 29, p. 2003666, 2021.
[16] H. Yang, M. Jing, L. Wang, H. Xu, X. Yan, and X. He, “PDOL-based solid electrolyte toward practical application: opportunities and challenges,” Nano-Micro Letters, vol. 16, no. 1, p. 127, 2024.
[17] S.-K. Lee et al., “Highly cyclable lithium-sulfur batteries with a dual-type sulfur cathode and a lithiated Si/SiO x nanosphere anode,” Nano Letters, vol. 15, no. 5, pp. 2863-2868, 2015.
[18] C. Huang et al., “Manipulating surface reactions in lithium-sulphur batteries using hybrid anode structures,” Nature communications, vol. 5, no. 1, p. 3015, 2014.
[19] Y. Liu et al., “Electrolyte solutions design for lithium-sulfur batteries,” Joule, vol. 5, no. 9, pp. 2323-2364, 2021.
[20] L. Suo, Y.-S. Hu, H. Li, M. Armand, and L. Chen, “A new class of solvent-in-salt electrolyte for high-energy rechargeable metallic lithium batteries,” Nature communications, vol. 4, no. 1, p. 1481, 2013.
[21] Y. Yamada and A. Yamada, “Superconcentrated electrolytes for lithium batteries,” Journal of The Electrochemical Society, vol. 162, no. 14, p. A2406, 2015.
[22] C. M. Efaw et al., “Localized high-concentration electrolytes get more localized through micelle-like structures,” Nature Materials, vol. 22, no. 12, pp. 1531-1539, 2023.
[23] H. Ji et al., “Weakening Li+de-solvation barrier for cryogenic Li—S pouch cells,” Advanced Materials, vol. 35, no. 9, p. 2208590, 2023.
[24] Z. Li et al., “Correlating Polysulfide Solvation Structure with Electrode Kinetics towards Long-Cycling Lithium-Sulfur Batteries,” Angewandte Chemie, vol. 135, no. 43, p. e202309968, 2023.
[25] L. Gomes et al., “Solvent Dynamics in Gel Polymer Electrolytes for Lithium-Sulfur Batteries,” ACS nano, vol. 19, no. 21, pp. 19715-19729, 2025.
[26] S. Li, W. Zhang, J. Zheng, M. Lv, H. Song, and L. Du, “Inhibition of polysulfide shuttles in Li—S batteries: modified separators and solid-state electrolytes,” Advanced Energy Materials, vol. 11, no. 2, p. 2000779, 2021.
[27] B. Yang, H. Jiang, Y. Zhou, Z. Liang, T. Zhao, and Y.-C. Lu, “Critical role of anion donicity in Li₂S deposition and sulfur utilization in Li—S batteries,” ACS applied materials & interfaces, vol. 11, no. 29, pp. 25940-25948, 2019.
[28] D. Aurbach, E. Pollak, R. Elazari, G. Salitra, C. S. Kelley, and J. Affinito, “On the surface chemical aspects of very high energy density, rechargeable Li-sulfur batteries,” Journal of the Electrochemical Society, vol. 156, no. 8, p. A694, 2009.
[29] K. S. Han et al., “Effects of anion mobility on electrochemical behaviors of lithium-sulfur batteries,” Chemistry of Materials, vol. 29, no. 21, pp. 9023-9029, 2017.
[30] R. Cao et al., “Effect of the anion activity on the stability of Li metal anodes in lithium-sulfur batteries,” Advanced Functional Materials, vol. 26, no. 18, pp. 3059-3066, 2016.
[31] B. Rezaei and M. Taki, “Effects of tetrabutylammonium hydrogen sulfate as an electrolyte additive on the electrochemical behavior of lead acid battery,” Journal of Solid State Electrochemistry, vol. 12, pp. 1663-1671, 2008.
[32] D. Chinnadurai et al., “Chloride-Free Electrolyte Based on Tetrabutylammonium Triflate Additive for Extended Anodic Stability in Magnesium Batteries,” Nano Letters, vol. 23, no. 23, pp. 11233-11242, 2023.
[33] K.-C. Lau, N. L. D. Rago, and C. Liao, “Lipophilic additives for highly concentrated electrolytes in lithium-sulfur batteries,” Journal of the Electrochemical Society, vol. 166, no. 12, p. A2570, 2019.
[34] Z. Liang et al., “Atomically dispersed Fe in a C2N based catalyst as a sulfur host for efficient lithium-sulfur batteries,” Advanced energy materials, vol. 11, no. 5, p. 2003507, 2021.
[35] H. Lin et al., “Simultaneous cobalt and phosphorous doping of MoS2 for improved catalytic performance on polysulfide conversion in lithium-sulfur batteries,” Advanced Energy Materials, vol. 9, no. 38, p. 1902096, 2019.
[36] M. U. Patel, I. Arcon, G. Aquilanti, L. Stievano, G. Mali, and R. Dominko, “X-ray absorption near-edge structure and nuclear magnetic resonance study of the lithium-sulfur battery and its components,” ChemPhysChem, vol. 15, no. 5, pp. 894-904, 2014.
[37] J.-X. Xue et al., “Effect of polymerizing on lithium-ion transport in electrolyte,” Ionics, vol. 29, no. 2, pp. 591-601, 2023.
[38] Q. Zhao et al., “Designing electrolytes with polymerlike glass-forming properties and fast ion transport at low temperatures,” Proceedings of the National Academy of Sciences, vol. 117, no. 42, pp. 26053-26060, 2020.
[39] S. Schaefer, H. Wang, L. Ren, S. Fu, and H. Wang, “Investigation of Lithium Polysulfide Reduction Associated with the Potential-Limiting Step in Lithium-Sulfur Batteries,” ACS Applied Materials & Interfaces, 2025.
[40] N. Elgrishi, K. J. Rountree, B. D. McCarthy, E. S. Rountree, T. T. Eisenhart, and J. L. Dempsey, “A practical beginner's guide to cyclic voltammetry,” Journal of chemical education, vol. 95, no. 2, pp. 197-206, 2018.
[41] Z. Li, I. Sami, J. Yang, J. Li, R. V. Kumar, and M. Chhowalla, “Lithiated metallic molybdenum disulfide nanosheets for high-performance lithium-sulfur batteries,” Nature Energy, vol. 8, no. 1, pp. 84-93, 2023.
[42] F. L. Lama, V. Marangon, A. Caballero, J. Morales, and J. Hassoun, “Diffusional Features of a Lithium-Sulfur Battery Exploiting Highly Microporous Activated Carbon,” ChemSusChem, vol. 16, no. 6, p. e202202095, 2023.
[43] S. Yuan et al., “Deshielding anions enable solvation chemistry control of LiPF6-based electrolyte toward low-temperature lithium-ion batteries,” Advanced Materials, vol. 36, no. 16, p. 2311327, 2024.
[44] H. Dai et al., “Mechanistic Understanding of a Bifunctional Carbonate Additive for Enhanced Performance in Lithium-Sulfur Battery,” Energy Storage Materials, p. 104123, 2025.
[45] S. Parab et al., “Quantitative Insights for Diagnosing Performance Bottlenecks in Lithium-Sulfur Batteries,” Energy & Environmental Science, 2025.
[46] M. Liu et al., “Tailoring cathode-electrolyte interface for high-power and stable lithium-sulfur batteries,” Nano-Micro Letters, vol. 17, no. 1, p. 85, 2025.
[47] Z. Wang et al., “Balancing Anodic Stability and Cathodic Kinetics in Practical Lithium-Sulfur Batteries With Non-fluorinated Weakly Solvating Solvents,” Advanced science (Weinheim, Baden-Wurttemberg, Germany), p. e17305.
[48] A. Maradesa et al., “Advancing electrochemical impedance analysis through innovations in the distribution of relaxation times method,” Joule, vol. 8, no. 7, pp. 1958-1981, 2024.
[49] T. H. Wan, M. Saccoccio, C. Chen, and F. Ciucci, “Influence of the discretization methods on the distribution of relaxation times deconvolution: implementing radial basis functions with DRTtools,” Electrochimica Acta, vol. 184, pp. 483-499, 2015.
[50] S. Lang, S.-H. Yu, X. Feng, M. R. Krumov, and H. D. Abruña, “Understanding the lithium-sulfur battery redox reactions via operando confocal Raman microscopy,” Nature communications, vol. 13, no. 1, p. 4811, 2022.
[51] Z. Zhang et al., “Prussian blue analog Co3 [Co (CN) 6] 2 as a cathode material for lithium-sulfur batteries,” Applied Physics Letters, vol. 117, no. 16, 2020.
[52] T. J. Leckie, S. D. Robertson, and E. Brightman, “Recent advances in in situ/operando characterization of lithium sulfur batteries,” Energy Advances, 2024.
[53] S. Xin et al., “Smaller sulfur molecules promise better lithium-sulfur batteries,” Journal of the American Chemical Society, vol. 134, no. 45, pp. 18510-18513, 2012.
[54] Y. Chen et al., “3D graphene framework supported Li 2 S coated with ultra-thin Al 2 O 3 films: binder-free cathodes for high-performance lithium sulfur batteries,” Journal of Materials Chemistry A, vol. 5, no. 1, pp. 102-112, 2017.
[55] P. He and J. L. Schaefer, “The Key Role of Magnesium Polysulfides in the Development of Mg—S Batteries,” ACS Energy Letters, vol. 7, no. 12, pp. 4352-4361, 2022.
[56] M. Hagen et al., “In-situ Raman investigation of polysulfide formation in Li—S cells,” Journal of The Electrochemical Society, vol. 160, no. 8, p. A1205, 2013.
[57] R. Kiani et al., “Ab Initio Simulation of Raman Fingerprints of Sulfur/Carbon Copolymer Cathodes During Discharge of Li—S Batteries,” ChemPhysChem, vol. 26, no. 3, p. e202400681, 2025.
[58] R. Bouchal, C. Pechberty, A. Boulaoued, N. Lindahl, and P. Johansson, “Tri-sulfur radical trapping in lithium-sulfur batteries,” Journal of Power Sources Advances, vol. 28, p. 100153, 2024.
[59] J. Thapa, B. Liu, S. D. Woodruff, B. T. Chorpening, and M. P. Buric, “Raman scattering in single-crystal sapphire at elevated temperatures,” Applied optics, vol. 56, no. 31, pp. 8598-8606, 2017.
[60] V. Mohaček-Grošev, K. Furić, and H. Ivanković, “Observed bands in Raman and infrared spectra of 1, 3-dioxolane and their assignments,” Vibrational spectroscopy, vol. 64, pp. 101-107, 2013.
[61] Q. Zhao, X. Liu, S. Stalin, K. Khan, and L. A. Archer, “Solid-state polymer electrolytes with in-built fast interfacial transport for secondary lithium batteries,” Nature Energy, vol. 4, no. 5, pp. 365-373, 2019.
[62] Y. Wu, Y. Bai, W. Dong, X. Wang, W. Ma, and F. Huang, “In-situ construction of PDOL electrolyte with dual-reinforced stable interface for high-voltage lithium metal batteries,” Science China Chemistry, vol. 67, no. 5, pp. 1664-1671, 2024.
[63] E. Raamat et al., “Acidities of strong neutral Brønsted acids in different media,” Journal of Physical Organic Chemistry, vol. 26, no. 2, pp. 162-170, 2013.
[64] S. Patai, “Sulphonic Acids, Esters and their Derivatives (1991),” (No Title), 1991.
[65] R. S. Tipson, “Infrared spectroscopy of carbohydrates: a review of the literature,” 1968.
[66] B. Laik, L. Legrand, A. Chausse, and R. Messina, “Ion-ion interactions and lithium stability in a crosslinked PEO containing lithium salts,” Electrochimica acta, vol. 44, no. 5, pp. 773-780, 1998.
[67] Q. J. Meisner, S. Jiang, P. Cao, T. Glossmann, A. Hintennach, and Z. Zhang, “An in situ generated polymer electrolyte via anionic ring-opening polymerization for lithium-sulfur batteries,” Journal of Materials Chemistry A, vol. 9, no. 46, pp. 25927-25933, 2021.
[68] Q. Wang et al., “In situ catalytic polymerization of LiNO3-containing PDOL electrolytes for high-energy quasi-solid-state lithium metal batteries,” Chemical Engineering Journal, vol. 484, p. 149757, 2024.
[69] A. Natarajan, A. M. Stephan, C. H. Chan, N. Kalarikkal, and S. Thomas, “Electrochemical studies on composite gel polymer electrolytes for lithium sulfur-batteries,” Journal of Applied Polymer Science, vol. 134, no. 11, 2017.

What is claimed is:

1. An electrolyte for a lithium-sulfur battery, the electrolyte comprising:
(i) a catalyst compound comprising an anion and a cation;
wherein the cation has a structure corresponding to Formula (I): 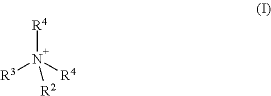
wherein each of R¹-R⁴ is independently selected from C2 to C8 alkyl groups;
wherein each alkyl group is selected from unbranched, branched and cyclic; and
(ii) a solvent.

2. The electrolyte of claim 1, wherein said alkyl group are C3 to C6 alkyl groups.

3. The electrolyte of claim 1, wherein the catalyst is a tetrabutylammonium (TBA) compound.

4. The electrolyte of claim 3, wherein the tetrabutylammonium (compound is selected from the group consisting of tetrabutylammonium trifluoro-methanesulfonate (TBA-TFMS), tetrabutylammonium bis-trifluoro-methanesulfonimidate (TBA-FSI), tetrabutylammonium thiocyanate (TBA-SCN), tetrabutylammonium methanesulfonate (TBA-MS), tetrabutylammonium nitrate (TBA-NO₃), tetrabutylammonium perchlorate (TBA-ClO₄), and tetrabutylammonium hexafluorophosphate (TBA-PF₆).

5. The electrolyte of claim 1, wherein the solvent is selected from the group consisting of 1,2-dimethoxyethane (DME), 1,3-dioxolane (DOL), ethanol (ETOH), dimethylacetamide (DMA), a glyme based solvent, diglyme (G2), triglyme, an ionic liquid, a hydrofluoroether, dimethyl sulfoxide (DMSO), N,N-dimethyl acetamide (DMAc), N,N-dimethyl formamide (DMF), N-methyl-2-pyrrolidone (NMP), and a combination of at least two of the aforementioned, and preferably wherein the solvent is selected from the group consisting of selected from the group consisting of 1,2-dimethoxyethane (DME), 1,3-dioxolane (DOL), ethanol (ETOH), dimethylacetamide (DMA), and combinations of two or more of the aforementioned.

6. The electrolyte of claim 1, wherein the solvent has a polysulfide solubility up to around 0.5 M, an electrochemical stability in a range of 1.2 to 4.2 V, and an ionic conductivity in a range of 1 to 20 mS/cm at 25° C.

7. The electrolyte of claim 1, wherein the concentration of the catalyst in the electrolyte is in a range from 0.01 M to 1.0 M, and preferably in a range of 0.01 M to 0.10 M.

8. The electrolyte of claim 1, wherein the catalyst is present in the electrolyte in a range of 1 wt. % to 10 wt. %, preferably in a range of 1 wt. % to 8 wt. %, more preferably in a range of 1 wt. % to 6 wt. %, and most preferably at a concentration of about 5 wt. %.

9. A lithium-sulfur battery comprising the electrolyte of claim 1.

10. The lithium-sulfur battery of claim 9, configured as a rechargeable coin battery.

11. The lithium-sulfur battery of claim 9,
wherein after 300 cycles at C/2, the lithium-sulfur battery has a specific capacity in a range of 369.76 mAh/gS to 394.83 mAh/gS.

12. The lithium-sulfur battery of claim 9,
wherein after 300 cycles at C/2, the lithium-sulfur battery has a capacity decay rate per cycle in a range of 0.07% to 0.10%.

13. The lithium-sulfur battery of claim 9,
wherein after 300 cycles at 1C, the lithium-sulfur battery has a specific capacity in a range of 395.74 mAh/gS to 397.48 mAh/gS.

14. The lithium-sulfur battery of claim 9,
wherein after 300 cycles at 1C, the lithium-sulfur battery has a capacity fading per cycle after stabilization in a range of 0.08% to 0.12%.

15. The lithium-sulfur battery of claim 9,
wherein at 1C, the lithium-sulfur battery has a specific capacity in a range of 443.84 mAh/gS to 540.6 mAh/gS.

16. An electronic device comprising the lithium-sulfur battery of claim 9.

17. A method of making an electrolyte for a lithium-sulfur battery, the method comprising dissolving the catalyst of claim 9 in a solvent to form the electrolyte.

18. The method of claim 17, wherein the catalyst is a tetrabutylammonium (TBA) compound selected from the group consisting of tetrabutylammonium trifluoro-methanesulfonate (TBA-TFMS), tetrabutylammonium bis-trifluoro-methanesulfonimidate (TBA-FSI), tetrabutylammonium thiocyanate (TBA-SCN), tetrabutylammonium methanesulfonate (TBA-MS), tetrabutylammonium nitrate (TBA-NO₃), tetrabutylammonium perchlorate TBA-ClO₄), and tetrabutylammonium hexafluorophosphate (TBA-PF₆).

19. The method of claim 17, wherein the solvent is selected from the group consisting of 1,2-dimethoxyethane (DME), 1,3-dioxolane (DOL), ethanol (ETOH), dimethylacetamide (DMA), a glyme based solvent, diglyme (G2), triglyme, an ionic liquid, a hydrofluoroether, dimethyl sulfoxide (DMSO), N,N-dimethyl acetamide (DMAc), N,N-dimethyl formamide (DMF), and N-methyl-2-pyrrolidone (NMP).

20. The method of claim 17, wherein the concentration of the catalyst in the electrolyte is in a range from 0.01 M to 1.0 M, and preferably in a range of 0.01 to 0.10 M.
